(19) United States
(12) Patent Application Publication
(10) Pub. No.: US 2021/0117704 A1
(43) Pub. Date: Apr. 22, 2021

(54) OBSTACLE DETECTION METHOD, INTELLIGENT DRIVING CONTROL METHOD, ELECTRONIC DEVICE, AND NON-TRANSITORY COMPUTER-READABLE STORAGE MEDIUM

(71) Applicant: Sensetime Group Limited, Hong Kong (CN)

(72) Inventors: Xinghua YAO, Hong Kong (CN); Xingyu ZHOU, Hong Kong (CN); Runtao LIU, Hong Kong (CN); Xingyu ZENG, Hong Kong (CN)

(73) Assignee: Sensetime Group Limited, Hong Kong (CN)

(21) Appl. No.: 17/137,542

(22) Filed: Dec. 30, 2020

Related U.S. Application Data
(63) Continuation of application No. PCT/CN2019/120833, filed on Nov. 26, 2019.

(30) Foreign Application Priority Data
Jun. 27, 2019 (CN) 201910566416.2

(51) Int. Cl. G06K 9/00; G06T 7/593; G06T 7/70; G06K 9/62

(52) U.S. Cl. CPC G06K 9/00805; G06T 7/593; G06T 7/70; G06T 2207/30261; G06K 9/6218; G06T 2207/20228; G06K 9/6202

(57) ABSTRACT

Implementation modes of the disclosure disclose an obstacle detection method, an intelligent driving control method, an electronic device, and a non-transitory computer-readable storage medium. The obstacle detection method includes that: a first disparity map of an environment image is obtained, the environment image being an image representing information of a space environment where an intelligent device is moving; multiple obstacle pixel areas are determined in the first disparity map; the multiple obstacle pixel areas are clustered to obtain at least one class cluster; and an obstacle detection result is determined according to the obstacle pixel areas belonging to the same class cluster.

### CROSS-REFERENCE TO RELATED APPLICATIONS

The application is a continuation under 35 U.S.C. § 120 of International Application No. PCT/CN2019/120833, filed on Nov. 26, 2019, which claims priority under 35 U.S.C. § 119(a) and/or PCT Article 8 to Chinese Patent Application No. 201910566416.2, filed on Jun. 27, 2019, the disclosures of which are hereby incorporated by reference in their entireties.

### TECHNICAL FIELD

The disclosure relates to the computer vision technology, in particular to an obstacle detection method, an intelligent driving control method, an electronic device, and a non-transitory computer-readable storage medium.

### BACKGROUND

In the field of computer vision technology, a perception technology is usually used to perceive the external obstacles. That is, the perception technology includes obstacle detection.

A perception result of the perception technology is usually provided to a decision layer, so that the decision layer makes decision based on the perception result. For example, in an intelligent driving system, a perception layer provides perceived information of a road where a vehicle is and information of an obstacle around the vehicle to the decision layer, so that the decision layer can make a driving decision to avoid the obstacles and ensure the safe driving of the vehicle. In a related art, the types of the obstacles are generally predefined, such as pedestrians, vehicles, non-motor vehicles and other obstacles with inherent shape, texture and color, and then the obstacles, the types of which are predefined, are detected by using the relevant detection algorithm.

### SUMMARY

According to a first aspect of the implementation modes of the disclosure, an obstacle detection method is provided, which may include: a first disparity map of an environment image is obtained, the environment image being an image representing information of a space environment where an intelligent device is moving. Multiple obstacle pixel areas are determined in the first disparity map of the environment image. The multiple obstacle pixel areas are clustered to obtain at least one class cluster. An obstacle detection result is determined according to the obstacle pixel areas belonging to the same class cluster.

According to a second aspect of the implementation modes of the disclosure, an intelligent driving control method is provided, which may include: an environment image of an intelligent device during moving is obtained via an image acquisition apparatus mounted on the intelligent device. Obstacle detection is performed on the obtained environment image and an obstacle detection result is determined by using the obstacle detection method. A control instruction is generated and output according to the obstacle detection result.

According to a third aspect of the implementation modes of the disclosure, an electronic device is provided. The electronic device includes at least one processor and a non-transitory computer readable storage. The computer readable storage is coupled to the at least one processor and stores at least one computer executable instruction thereon which, when executed by the at least one processor, causes the at least one processor to perform the method of the first aspect or the second method described above.

According to a fourth aspect, a non-transitory computer-readable storage medium storing computer programs which, when executed by a processor, cause the processor to perform the method of the first aspect.

### BRIEF DESCRIPTION OF THE DRAWINGS

The drawings forming a part of the specification describe the implementation modes of the disclosure and, together with the descriptions, are adopted to explain the principle of the disclosure.

Referring to the drawings, the disclosure may be understood more clearly according to the following detailed descriptions.

FIG. 1 is a flowchart of an implementation mode of an obstacle detection method according to the disclosure.

FIG. 2 is a schematic diagram of an implementation mode of an environment image according to the disclosure.

FIG. 3 is a schematic diagram of an implementation mode of a first disparity map shown in FIG. 2.

FIG. 4 is a schematic diagram of an implementation mode of a first disparity map according to the disclosure.

FIG. 5 is a schematic diagram of an implementation mode of a Convolutional Neural Network (CNN) according to the disclosure.

FIG. 6 is a schematic diagram of an implementation mode of a first weight distribution map of a first disparity map according to the disclosure.

FIG. 7 is a schematic diagram of another implementation mode of a first weight distribution map of a first disparity map according to the disclosure.

FIG. 8 is a schematic diagram of an implementation mode of a second weight distribution map of a first disparity map according to the disclosure.

FIG. 9 is a schematic diagram of an implementation mode of a second mirror image according to the disclosure.

FIG. 10 is a schematic diagram of an implementation mode of a second weight distribution map of a second mirror image shown in FIG. 9.

FIG. 11 is a schematic diagram of an implementation mode for optimizing and adjusting a disparity map of a monocular image according to the disclosure.

FIG. 12 is a schematic diagram of an implementation mode of obstacle edge information in a first disparity map of an environment image according to the disclosure.

FIG. 13 is a schematic diagram of an implementation mode of a statistical disparity map according to the disclosure.

FIG. 14 is a schematic diagram of an implementation mode for forming a statistical disparity map according to the disclosure.

FIG. 15 is a schematic diagram of an implementation mode of linear fitting according to the disclosure.

FIG. 16 is a schematic diagram of a ground area and a non-ground area according to the disclosure.

FIG. 17 is a schematic diagram of an implementation mode of a coordinate system established in the disclosure.

FIG. 18 is a schematic diagram of two areas contained in a first area above the ground in the disclosure.

FIG. 19 is a schematic diagram of an implementation mode for forming an obstacle pixel columnar area according to the disclosure.

FIG. 20 is a schematic diagram of an implementation mode for clustering an obstacle pixel columnar area according to the disclosure.

FIG. 21 is a schematic diagram of an implementation mode for forming an obstacle bounding-box according to the disclosure.

FIG. 22 is a flowchart of an implementation mode of a CNN training method according to the disclosure.

FIG. 23 is a flowchart of an implementation mode of an intelligent driving control method according to the disclosure.

FIG. 24 is a structural schematic diagram of an implementation mode of an obstacle detection apparatus according to the disclosure.

FIG. 25 is a flowchart of an implementation mode of an intelligent driving control apparatus according to the disclosure.

FIG. 26 is a block diagram of an exemplary device implementing an implementation mode of the disclosure.

### DETAILED DESCRIPTION OF THE EMBODIMENTS

Each exemplary embodiment of the disclosure will now be described with reference to the drawings in detail. It is to be noted that relative arrangement of components and steps, numeric expressions and numeric values elaborated in these embodiments do not limit the scope of the disclosure, unless otherwise specifically described.

In addition, it is to be understood that, for convenient description, the size of each part shown in the drawings is not drawn according to a practical proportional relationship. The following descriptions of at least one exemplary embodiment are only illustrative in fact and not intended to form any limit to the disclosure and application or use thereof. Technologies, methods and devices known to those of ordinary skill in the art may not be discussed in detail, but the technologies, the methods and the devices should be considered as a part of the specification as appropriate. It is to be noted that similar reference signs and letters represent similar terms in the following drawings and thus a certain term, once defined in a drawing, is not required to be further discussed in subsequent drawings.

The embodiments of the disclosure may be applied to an electronic device such as a terminal device, a computer system and a server, which may be operated together with numerous other universal or dedicated computing system environments or configurations. Examples of well-known terminal device computing systems, environments and/or configurations suitable for use together with the electronic device such as the terminal device, the computer system and the server include, but are not limited to, a Personal Computer (PC) system, a server computer system, a thin client, a thick client, a handheld or laptop device, a microprocessor-based system, a set-top box, a programmable consumer electronic product, a network PC, a microcomputer system, a large computer system, a distributed cloud computing technical environment including any abovementioned system, and the like.

The electronic device such as the terminal device, the computer system and the server may be described in a general context of a computer system executable instruction (for example, a program module) executed by the computer system. Under a normal condition, the program module may include a routine, a program, a target program, a component, a logic, a data structure and the like, and they execute specific tasks or implement specific abstract data types. The computer system/server may be implemented in a distributed cloud computing environment, and in the distributed cloud computing environment, tasks are executed by a remote processing device connected through a communication network. In the distributed cloud computing environment, the program module may be in a storage medium of a local or remote computer system including a storage device.

### Exemplary Embodiment

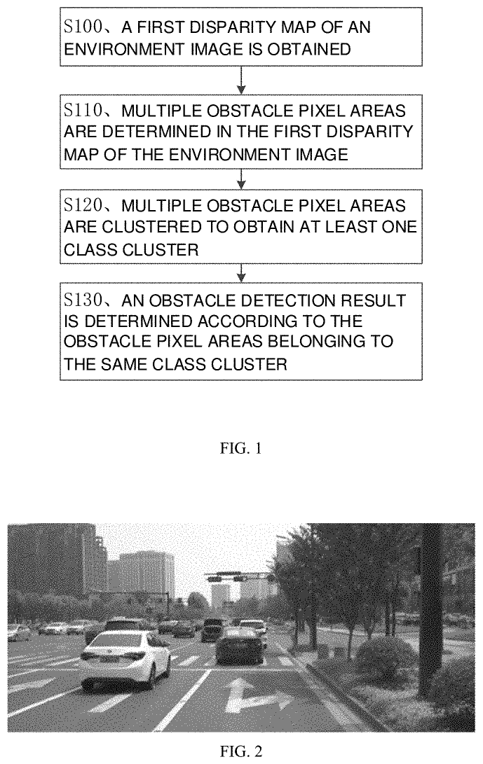

FIG. 1 is a flowchart of an embodiment of an obstacle detection method according to the disclosure. As shown in FIG. 1, the method of the embodiment includes S100, S110, S120 and S130. Each step will be described below in detail.

At S100, a first disparity map of an environment image is obtained. The environment image is an image representing information of a space environment where an intelligent device is moving.

Exemplarily, intelligent devices are, for example, intelligent driving devices (such as a self-driving car), intelligent flying devices (such as a drone), intelligent robots, etc. The environment image is, for example, an image representing information of a road space environment where the intelligent driving device or the intelligent robot is moving, or information of space environment where the intelligent flying device is flying. Of course, the intelligent device and the environment image in the disclosure are not limited to the above examples and are not limited by the disclosure.

In the disclosure, an obstacle in the environment image is detected. Any object that may hinder the moving process in the surrounding environment where the intelligent device is may fall into an obstacle detection range and be regarded as an obstacle detection object. For example, in the driving process of the intelligent driving device, objects such as rocks, animals and fallen goods may appear on the road surface. These objects have no specific shape, texture, color or category, and are very different from each other, so all of them can be regarded as obstacles. In the disclosure, any above object that may cause a hindrance in the moving process is called a generic type obstacle.

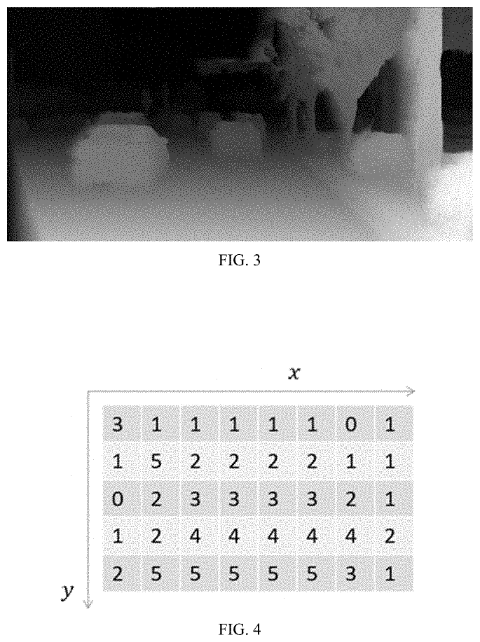

In an optional example, the first disparity map of the disclosure is used to describe a disparity of the environment image. The disparity may be considered as the difference between the positions of a target object when the same target object is observed from two positions at a certain distance. An example of the environment image is shown in FIG. 2. An example of a first disparity map of the environment image shown in FIG. 2 is shown in FIG. 3. Optionally, the first disparity map of the environment image in the disclosure may also be represented in the form shown in FIG. 4. The numbers (such as 0, 1, 2, 3, 4, and 5) in FIG. 4 respectively represent the disparity of the pixel at the position (x, y) in the environment image. It is to be particularly noted that FIG. 4 does not show a complete disparity map.

In an optional embodiment, the environment image in the disclosure may be a monocular image or a binocular image. The monocular image is usually the image obtained by using a monocular camera device. The binocular image is usually the image obtained by using a binocular camera device. Optionally, both the monocular image and the binocular image in the disclosure may be a photo or a picture, etc., or a video frame in a video. When the environment image is the monocular image, the disclosure may realize obstacle detection without the need of setting the binocular camera device, thus helping to reduce the cost of obstacle detection.

In an optional implementation mode, when the environment image is the monocular image, the disclosure may use a CNN which is successfully trained in advance to obtain the first disparity map of the monocular image. For example, the monocular image is input in the CNN; then, the CNN performs disparity analysis to the monocular image and outputs a disparity analysis result. In this way, the disclosure may obtain the first disparity map of the monocular image based on the disparity analysis result. By using the CNN to obtain the first disparity map of the monocular image, the first disparity map may be obtained without using two images to calculate the disparity pixel by pixel and without calibrating the camera device. In this way, it is helpful to improve the convenience and real-time performance of obtaining the first disparity map.

In an optional example, the CNN in the disclosure usually includes, but is not limited to: multiple convolution layers (Cony) and multiple deconvolution layers (Deconv). The CNN of the disclosure may be divided into two parts, that is, a coding part and a decoding part. The monocular image (the monocular image as shown in FIG. 2) input into the CNN is coded (that is, feature extraction) by the coding part. A coding result of the coding part is provided to the decoding part, and the decoding part decodes the coding result and outputs a decoding result. The disclosure may obtain the first disparity map (the first disparity map as shown in FIG. 3) of the monocular image according to the decoding result output by the CNN. Optionally, the coding part in the CNN includes, but is not limited to, multiple convolution layers which are connected in series. The decoding part in the CNN includes, but is not limited to, multiple convolution layers and multiple deconvolution layers. The multiple convolution layers and multiple deconvolution layers are set apart from each other and connected in series.

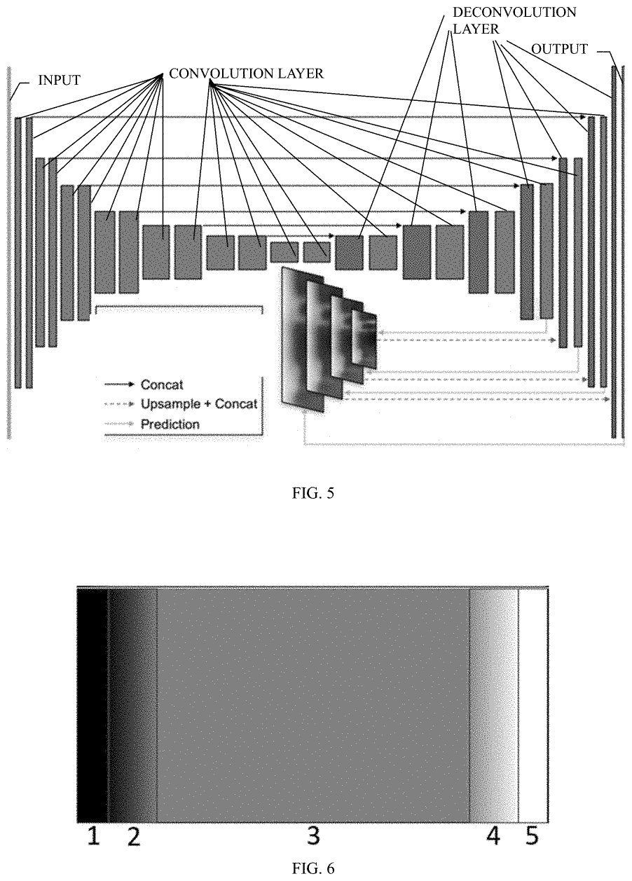

An optional example of the CNN in the disclosure is shown in FIG. 5. In FIG. 5, the first rectangle on the left represents the monocular image input into the CNN, and the first rectangle on the right represents the disparity map output from the CNN. Each of the rectangles from the 2nd rectangle to 15th rectangle on the left represents the convolution layer, and all of the rectangles from the 16th rectangle on the left to the 2nd rectangle on the right represent the deconvolution layer and the convolution layer that are set apart from each other. For example, the 16th rectangle on the left represents the deconvolution layer, the 17th rectangle on the left represents the convolution layer, the 18th rectangle on the left represents the deconvolution layer, the 19th rectangle on the left represents the convolution layer, and so on, until the 2nd rectangle on the right, and the 2nd rectangle on the right represents the deconvolution layer.

In an optional example, the CNN in the disclosure may fuse low-level information and high-level information in the CNN by means of Skip Connect. For example, the output of at least one convolution layer in the coding part is provided to at least one deconvolution layer in the decoding part by means of Skip Connect. Optionally, the input of all the convolution layers in the CNN usually includes: the output of the previous layer (e.g., the convolution layer or the deconvolution layer). The input of the at least one deconvolution layer (e.g., a part of the deconvolution layer or all the deconvolution layer) in the CNN includes: an Upsample result output by the previous convolution layer and the output of the convolution layer of the coding part in skip connection with the deconvolution layer. For example, the content pointed by the solid arrow below the convolution layer on the right of FIG. 5 represents the output of the convolution layer, the dotted arrow in FIG. 5 represents the Upsample result provided to the deconvolution layer, and the solid arrow above the convolution layer on the left of FIG. 5 represents the output of the convolution layer in skip connection with the deconvolution layer. The disclosure does not limit the number of skip connections and the network structure of the CNN. By fusing the low-level information and the high-level information in the CNN, the disclosure is conducive to improving the accuracy of the disparity map generated by the CNN. Optionally, the CNN in the disclosure is trained with binocular image samples. The training process of the CNN may be described in the following implementation modes. It will not be elaborated here.

In an optional implementation mode, the disclosure may also optimize and adjust a first disparity map of an environment image obtained by using the CNN, so as to obtain a more accurate first disparity map. Optionally, when the environment image is the monocular image, the disclosure may use a disparity map of a mirror image of the monocular image to optimize and adjust the first disparity map of the monocular image, so that multiple obstacle pixel areas may be determined in the first disparity map subjected to disparity adjustment. For the convenience of description, the mirror image of the monocular image is called a first mirror image, and the disparity map of the first mirror image is called a second disparity map. Exemplarily, after the monocular image in the environment image is mirrored, a first mirror image may be obtained, and the disparity map of the first mirror image may be obtained; then, according to the disparity map of the first mirror image, the disparity of the first disparity map of the monocular image is adjusted to obtain the first disparity map subjected to disparity adjustment. Subsequently, multiple obstacle pixel areas may be identified in the first disparity map subjected to disparity adjustment. A specific example of optimizing and adjusting the first disparity map is shown below.

At Step A, the second disparity map of the first mirror image of the monocular image is obtained, and the mirror image of the second disparity map is obtained.

Optionally, the first mirror image of the monocular image in the disclosure may be a mirror image formed by horizontally mirroring (e.g., left mirroring or right mirroring) the monocular image. The mirror image of the second disparity map in the disclosure may be a mirror image formed by horizontally mirroring (e.g., left mirroring or right mirroring) the second disparity map. The mirror image of the second disparity map is still a disparity map. In the disclosure, the monocular image may be first mirrored left or right (because the result of left mirroring is the same as the result of right mirroring, the monocular image may be mirrored either left or right in the disclosure) to obtain the first mirror image (left mirror image or right mirror image) of the monocular image; then, the disparity map of the first mirror image of the monocular image is obtained to obtain the second disparity map; finally, the second disparity map is mirrored left or right (because the result of left mirroring the second disparity map is the same as the result of right mirroring, the second disparity map may be mirrored either left or right in the disclosure) to obtain the mirror image (the left mirror image or the right mirror image) of the second disparity map. The mirror image of the second disparity map is still the disparity map. For the convenience of description, the mirror image of the second disparity map is called the second mirror image below.

It can be seen from the above description that when the monocular image is mirrored in the disclosure, it is not necessary to consider whether the monocular image is mirrored as a left eye image or as a right eye image. That is, whether the monocular image is taken as the left eye image or the right eye image, the disclosure may mirror the monocular image left or right to obtain the first mirror image. Similarly, when the second disparity map is mirrored in the disclosure, it is also not necessary to consider whether the second disparity map is mirrored left or right. It is to be noted that in the process of training the CNN for generating the disparity map of the monocular image, if a left eye image sample in the binocular image sample is provided as input to the CNN for training, then the successfully trained CNN will take the input monocular image as the left eye image in the test and practical application. If a right eye image sample in the binocular image sample is provided as input to the CNN for training, then the successfully trained CNN will take the input monocular image as the right eye image in the test and practical application.

Optionally, the disclosure may also use the CNN to obtain the second disparity map. For example, the first mirror image is input into the CNN; then, the CNN performs disparity analysis to the first mirror image and outputs the disparity analysis result. In this way, the disclosure may obtain the second disparity map based on the output disparity analysis result.

At Step B, a weight distribution map of the first disparity map and a weight distribution map of the second mirror image of the monocular image are obtained.

In an optional example, the weight distribution map of the first disparity map is used for describing weight values corresponding respectively to multiple disparity values (e.g., all disparity values) in the first disparity map. The weight distribution map of the first disparity map may include, but may not be limited to: a first weight distribution map of the first disparity map and a second weight distribution map of the first disparity map. Optionally, the first weight distribution map of the first disparity map is a weight distribution map uniformly set for the disparity maps of multiple different monocular images, that is, the first weight distribution map of the first disparity map may be oriented to the first disparity maps of multiple different monocular images, further, the first disparity maps of different monocular images use the same first weight distribution map; therefore, the disclosure may call the first weight distribution map of the first disparity map as a global weight distribution map of the first disparity map. The global weight distribution map of the first disparity map is used for describing global weight values corresponding respectively to multiple disparity values (e.g., all disparity values) in the first disparity map. Optionally, the second weight distribution map of the first disparity map is a weight distribution map set for the first disparity map of a single monocular image, that is, the second weight distribution map of the first disparity map are oriented to the first disparity map of the single monocular image, further, the first disparity maps of different monocular images use different second weight distribution maps; therefore, the disclosure may call the second weight distribution map of the first disparity map as a local weight distribution map of the first disparity map. The local weight distribution map of the first disparity map is used for describing local weight values corresponding respectively to multiple disparity values (e.g., all disparity values) in the first disparity map.

In an optional example, the weight distribution map of the second mirror image is used for describing the weight values corresponding respectively to multiple disparity values in the second mirror image. The weight distribution map of the second mirror image may include, but may not be limited to: a first weight distribution map of the second mirror image and a second weight distribution map of the second mirror image. Optionally, the first weight distribution map of the second mirror image is a weight distribution map uniformly set for the second mirror image of multiple different monocular images, that is, the first weight distribution map of the second mirror image are oriented to the second mirror images of multiple different monocular images, further, the second mirror images of different monocular images use the same first weight distribution map; therefore, the disclosure may call the first weight distribution map of the second mirror image as a global weight distribution map of the second mirror image. The global weight distribution map of the second mirror image is used for describing the global weight values corresponding respectively to multiple disparity values (e.g., all disparity values) in second mirror image. Optionally, the second weight distribution map of the second mirror image is a weight distribution map set for the second mirror image of a single monocular image, that is, the second weight distribution map of the second mirror image are oriented to the second mirror image of a single monocular image, further, the second mirror images of different monocular images use different second weight distribution maps; therefore, the disclosure may call the second weight distribution map of the second mirror image as a local weight distribution map of the second mirror image. The local weight distribution map of the second mirror image is used for describing the local weight values corresponding respectively to multiple disparity values (e.g., all disparity values) in second mirror image.

In an optional example, the first weight distribution map of the first disparity map includes at least two areas separated to the left and right, and different areas have different weight values. Optionally, the relationship between the weight value of the area on the left and the weight value of the area on the right is usually related to whether the monocular image is taken as the left eye image or the right eye image.

For example, when the monocular image is taken as the left eye image, for any two areas in the first weight distribution map of the first disparity map, the weight value of the area on the right is not less than the weight value of the area on the left. FIG. 6 is the first weight distribution map of the first disparity map as shown in FIG. 3. The first weight distribution map is divided into five areas, that is, area 1, area 2, area 3, area 4 and area 5 in FIG. 6. The weight value of area 5 is not less than the weight value of area 4, the weight value of area 4 is not less than the weight value of area 3, the weight value of area 3 is not less than the weight value of area 2, and the weight value of area 1 is not less than the weight value of area 1. In addition, any area in the first weight distribution map of the first disparity map may have either the same weight value or different weight values. When an area in the first weight distribution map of the first disparity map has different weight values, the weight value of the left part of the area is usually less than or equal to the weight value of the right part of the area. Optionally, the weight value of area 1 in FIG. 6 may be 0, that is, in the first disparity map, the disparity corresponding to area 1 is completely incredible. The weight value of area 2 can be increased gradually from 0 to 0.5 from left to right. The weight value of area 3 is 0.5. The weight value of area 4 can be gradually increased from a value greater than 0.5 to close to 1 from left to right. The weight value of area 5 is 1, that is, in the first disparity map, the disparity corresponding to area 5 is completely credible.

For another example, when the monocular image is taken as the right eye image, for any two areas in the first weight distribution map of the first disparity map, the weight value of the area on the left is not less than the weight value of the area on the right. FIG. 7 shows the first weight distribution map of the disparity map as the right eye image to be processed. The first weight distribution map is divided into five areas, that is, area 1, area 2, area 3, area 4 and area 5 in FIG. 7. The weight value of area 1 is not less than the weight value of area 2, the weight value of area 2 is not less than the weight value of area 3, the weight value of area 3 is not less than the weight value of area 4, and the weight value of area 4 is not less than the weight value of area 5. In addition, any area in the first weight distribution map of the first disparity map may have either the same weight value or different weight values. When an area in the first weight distribution map of the first disparity map has different weight values, the weight value of the right part of the area is usually not greater than the weight value of the left part of the area. Optionally, the weight value of area 1 in FIG. 7 may be 0, that is, in the first disparity map, the disparity corresponding to area 5 is completely incredible. The weight value in area 4 can be increased gradually from 0 to 0.5 from right to left. The weight value of area 3 is 0.5. The weight value in area 2 can be gradually increased from a value greater than 0.5 to close to 1 from right to left. The weight value of area 1 is 1, that is, in the first disparity map, the disparity corresponding to area 1 is completely credible.

Optionally, the first weight distribution map of the second mirror image includes at least two areas separated to the left and right, and different areas have different weight values. Optionally, the relationship between the weight value of the area on the left and the weight value of the area on the right is usually related to whether the monocular image is taken as the left eye image or the right eye image.

For example, when the monocular image is taken as the left eye image, for any two areas in the first weight distribution map of the second mirror image, the weight value of the area on the right is not less than the weight value of the area on the left. In addition, any area in the first weight distribution map of the second mirror image may have either the same weight value or different weight values. When an area in the first weight distribution map of the second mirror image has different weight values, the weight value of the left part of the area is usually not greater than the weight value of the right part of the area.

For another example, when the monocular image is taken as the right eye image, for any two areas in the first weight distribution map of the second mirror image, the weight value of the area on the left is not less than the weight value of the area on the right. In addition, any area in the first weight distribution map of the second mirror image may have either the same weight value or different weight values. When an area in the first weight distribution map of the second mirror image has different weight values, the weight value of the right part of the area is usually not greater than the weight value of the left part of the area.

Optionally, the setting mode of the second weight distribution map of the first disparity map may include the following steps.

First, the first disparity map is mirrored left/right to form a mirror disparity map.

Then, the weight value in the second weight distribution map of the first disparity map is set according to the disparity value in the mirror disparity map.

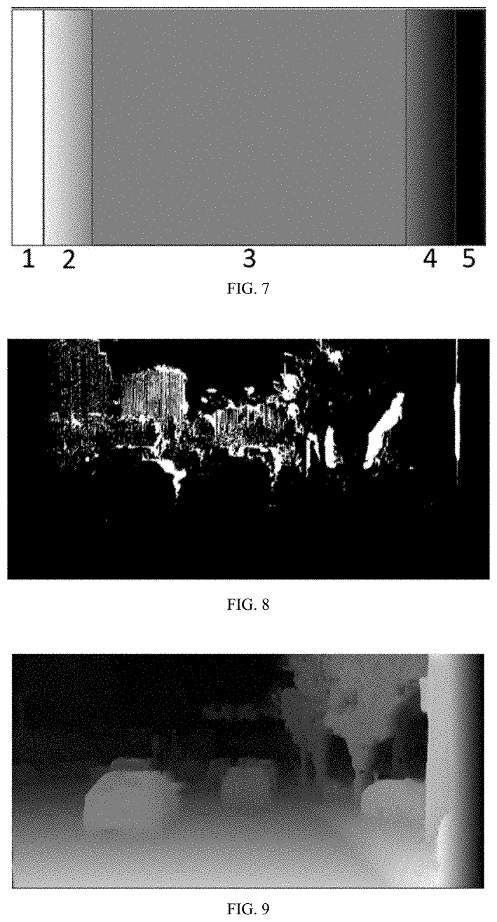

Optionally, for the pixel at any position in the mirror disparity map, if the disparity value of the pixel at the position satisfies a first predetermined condition, the weight value of the pixel at the position in the second weight distribution map of the first disparity map is set as a first value; and if the disparity value of the pixel does not satisfy the first predetermined condition, the weight value of the pixel at the position in the second weight distribution map of the first disparity map is set as a second value. For example, for the pixel at any position in the mirror disparity map, if the disparity value of the pixel at the position is greater than a first reference value corresponding to the pixel at the position, the weight value of the pixel at the position in the second weight distribution map of the first disparity map is set as a first value; or else, the weight value is set as a second value. In the disclosure, the first value is greater than the second value. For example, the first value is 1, and the second value is 0. Optionally, an example of the second weight distribution map of the first disparity map is shown in FIG. 8. The weight values of the white areas in FIG. 8 are all 1, indicating that the disparity value at the position is completely credible. The weight values of the black areas in FIG. 8 are 0, indicating that the disparity value at the position is completely incredible.

Optionally, in the disclosure, the first reference value corresponding to the pixel at any position may be set according to the disparity value of the pixel at the position in the first disparity map and a constant value that is greater than zero. For example, the product of the disparity value of the pixel point at the position in the first disparity map and the constant value greater than zero is taken as the first reference value corresponding to the pixel point at the position in the mirror disparity map.

Optionally, the second weight distribution map of the first disparity map may be represented by the following formula (1):

$${L}_{l} = \{ \begin{matrix}1 & if {d}_{flip}^{{l}^{′}} > {d}^{l} \cdot thresh 1 \\ 0 & else\end{matrix} \} . \qquad ( 1 )$$

In the formula (1), Lₗ represents the second weight distribution map of the first disparity map, d^{l}_{flip}′ represents the disparity value of the pixel at the corresponding position in the mirror disparity map, d^{l} represents the disparity value of the pixel at the corresponding position in the first disparity map, thresh1 represents the constant value that is greater than 0, and the value range of thresh1 may be 1.1-1.5, such as thresh1=1.2 or thresh2=1.25.

In an optional example, the setting mode of the second weight distribution map of the second mirror image may be that: according to the disparity value in the first disparity map, the weight value in the second weight distribution map of the second mirror image is set. Optionally, for the pixel at any position in the second mirror image, if the disparity value of the pixel at the position in the first disparity map satisfies a second predetermined condition, the weight value of the pixel at the position in the second weight distribution map of the second mirror image is set as a third value. If the disparity value of the pixel at the position in the first disparity map does not satisfy the second predetermined condition, the weight value of the pixel at the position in the second weight distribution map of the second mirror image is set as a fourth value. The third value is greater than the fourth value. For example, for the pixel at any position in the first disparity map, if the disparity value of the pixel at the position in the first disparity map is greater than a second reference value corresponding to the pixel at the position, the weight value of the pixel at the position in the second weight distribution map of the second mirror image is set as a third value; or else, the weight value is set as a fourth value. Optionally, the third value is greater than the fourth value in the disclosure. For example, the third value is 1, and the fourth value is 0.

Optionally, in the disclosure, the second reference value corresponding to the pixel may be set according to the disparity value of the pixel at the corresponding position in the mirror disparity map and the constant value that is greater than zero. For example, first the first disparity map is mirrored left/right to form the mirror disparity map, and then the product of the disparity value of the pixel at the corresponding position in the mirror disparity map and the constant value greater than zero is taken as the second reference value corresponding to the pixel at the corresponding position in the first disparity map.

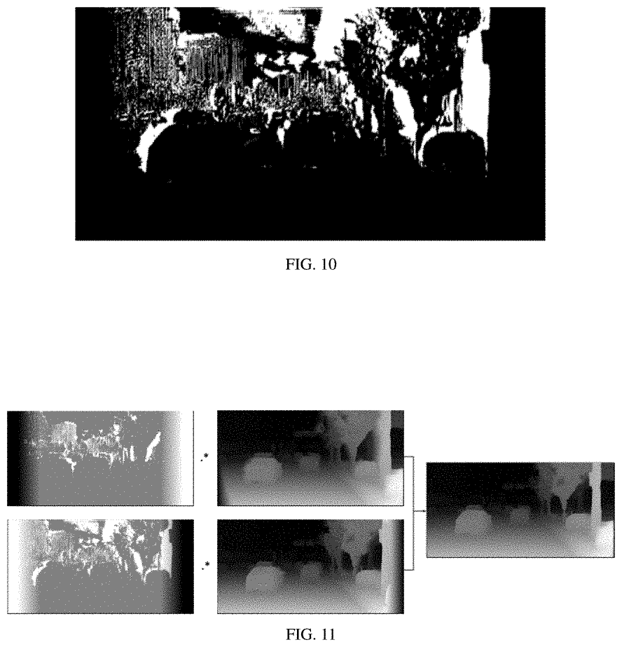

Optionally, based on the environment image in FIG. 2, an example of the formed second mirror image is shown in FIG. 9. An example of the second weight distribution map of the second mirror image in FIG. 9 is shown in FIG. 10. The weight values of the white areas in FIG. 10 are all 1, indicating that the disparity value at the position is completely credible. The weight values of the black areas in FIG. 10 are 0, indicating that the disparity value at the position is completely incredible.

Optionally, the second weight distribution map of the second mirror image may be represented by the following formula (2):

$${L}_{l}^{′} = \{ \begin{matrix}1 & if {d}^{l} > {d}_{flip}^{{l}^{′}} \cdot thresh 2 \\ 0 & else\end{matrix} \} . \qquad ( 2 )$$

In the formula (2), Lₗ′ represents the second weight distribution map of the second mirror image, d^{l}_{flip}′ represents the disparity value of the pixel at the corresponding position in the mirror disparity map, d^{l} represents the disparity value of the pixel at the corresponding position in the first disparity map, thresh2 represents the constant value that is greater than 0, and the value range of thresh2 may be 1.1-1.5, such as thresh2=1.2 or thresh2=1.25.

At Step C, the first disparity map of the monocular image is optimized and adjusted according to the weight distribution map of the first disparity map of the monocular image and the weight distribution map of the second mirror image, and the optimized and adjusted disparity map is the final first disparity map of the monocular image.

In an optional example, the disclosure may use the first weight distribution map and the second weight distribution map of the first disparity map to adjust multiple disparity values in the first disparity map, so as to obtain the adjusted first disparity map, and may use the first weight distribution map and the second weight distribution map of the second mirror image to adjust multiple disparity values in the second mirror image, so as to obtain the adjusted second mirror image; after that, the adjusted first disparity map and the adjusted second mirror image are fused to obtain the optimized and adjusted first disparity map of the monocular image.

Optionally, an example of obtaining the optimized and adjusted first disparity map of the monocular image is shown below.

First, the first weight distribution map of the first disparity map and the second weight distribution map of the first disparity map are fused to obtain a third weight distribution map. The third weight distribution map may be represented by the following formula (3):

Wₗ=Mₗ+Lₗ·0.5 (3).

In the formula (3), Wₗ represents the third weight distribution map, Mₗ represents the first weight distribution map of the first disparity map, Lₗ represents the second weight distribution map of the first disparity map, and 0.5 may also be converted to other constant values.

Secondly, the first weight distribution map of the second mirror image and the second weight distribution map of the second mirror image are fused to obtain a fourth weight distribution map. The fourth weight distribution map may be represented by the following formula (4):

Wₗ′=Mₗ′+Lₗ′·0.5 (4).

In the formula (4), Wₗ′ represents the fourth weight distribution map, Mₗ′ represents the first weight distribution map of the second mirror image, Lₗ′ represents the second weight distribution map of the second mirror image, and 0.5 may also be converted to other constant values.

Thirdly, multiple disparity values in the first disparity map are adjusted according to the third weight distribution map to obtain the adjusted first disparity map. For example, for the disparity value of the pixel at any position in the first disparity map, the disparity value of the pixel at the position is replaced with the product of the disparity value of the pixel at the position and the weight value of the pixel at the corresponding position in the third weight distribution map. After all the pixels in the first disparity map are replaced, the adjusted first disparity map is obtained.

And, multiple disparity values in the second mirror image are adjusted according to the fourth weight distribution map to obtain the adjusted second mirror image. For example, for the disparity value of the pixel at any position in the second mirror image, the disparity value of the pixel at the position is replaced with the product of the disparity value of the pixel at the position and the weight value of the pixel at the corresponding position in the fourth weight distribution map. After all the pixels in the second mirror image are replaced, the adjusted second mirror image is obtained.

Finally, the adjusted first disparity map and the adjusted second mirror image are fused to finally obtain the first disparity map of the monocular image. The first disparity map of the finally obtained monocular image may be represented by the following formula (5):

d_{final}=Wₗ·*dₗ+Wₗ′·*d^{l}_{flip}′ (5)

In the formula (5), d_{final} represents the finally obtained first disparity map of the monocular image (as shown in the first figure on the right of FIG. 11), Wₗ represents the third weight distribution map (as shown in the first figure on the top left of FIG. 11), Wₗ′ represents the fourth weight distribution map (as shown in the first figure on the bottom left of FIG. 11), dₗ represents the first disparity map (as shown in the second figure on the top left of FIG. 11), and d^{l}_{flip}′ represents the second mirror image (as shown in the second figure on the bottom left of FIG. 11).

It is to be noted that the disclosure does not limit the sequence of performing the two steps of fusing the first weight distribution map and the second weight distribution map. For example, the two fusing steps may be performed simultaneously or successively. In addition, the disclosure does not limit the sequence in which the disparity value in the first disparity map is adjusted and the disparity value in the second mirror image is adjusted. For example, the two steps may be performed simultaneously or successively.

When the monocular image is taken as the left eye image, there are usually left disparity loss and occlusion of the left edge of an object, which will lead to inaccurate disparity value in the corresponding area in the first disparity map of the monocular image. Similarly, when the monocular image is taken as the right eye image, there are usually right disparity loss and occlusion of the right edge of an object, which will lead to inaccurate disparity value in the corresponding area in the first disparity map of the monocular image. In the disclosure, by mirroring the monocular image and mirroring the second disparity map, and then using the mirrored disparity image (that is, the second mirror image) to optimize and adjust the first disparity map of the monocular image, it is beneficial to reduce the inaccuracy of the disparity value of the corresponding area in the first disparity map of the monocular image, and then improve the accuracy of obstacle detection.

In an optional example, in an application scenario where the environment image is the binocular image, the method for obtaining the first disparity map of the binocular image in the disclosure includes, but is not limited to, that: the first disparity map of the binocular image is obtained by means of stereo matching. For example, the first disparity map of the binocular image is obtained by using stereo matching algorithms, such as a Block Matching (BM) algorithm, a Semi-Global Block Matching (SGBM) algorithm, or a Graph Cuts (GC) algorithm. For another example, disparity processing is performed on the binocular image by using the CNN for obtaining the disparity map of the binocular image, so as to obtain the first disparity map of the binocular image.

At S110, multiple obstacle pixel areas are determined in the first disparity map of the environment image.

Exemplarily, the obstacle pixel area may be a pixel area containing at least two consecutive pixels in the first disparity map. In an implementation mode, the obstacle pixel area may be an obstacle pixel columnar area. For example, the obstacle pixel columnar area in the disclosure is a strip area, the width of which is at least one column of pixels, and the height of which is at least two rows of pixels. Because the strip area may be taken as the basic unit of the obstacle, the strip area is called the obstacle pixel columnar area in the disclosure.

In an optional example, in the disclosure, first edge detection is performed on the first disparity map of the environment image obtained by the above steps to obtain obstacle edge information; then, the obstacle area in the first disparity map of the environment image is determined; finally, according to the obstacle edge information, multiple obstacle pixel columnar areas are determined in the obstacle area. By dividing the obstacle area, the disclosure is conducive to avoiding the formation of obstacle pixel columnar area in the area with low value of concern, and is conducive to improving the convenience of forming the obstacle pixel columnar area. Different obstacles in the actual space will cause different disparities due to the different distances from the camera device, thus forming the existence of disparity edge of the obstacle. By detecting the obstacle edge information, the disclosure may separate the obstacles in the disparity map. Therefore, by searching the obstacle edge information, the disclosure may conveniently form the obstacle pixel columnar area, which is conducive to improving the convenience of forming the obstacle pixel columnar area.

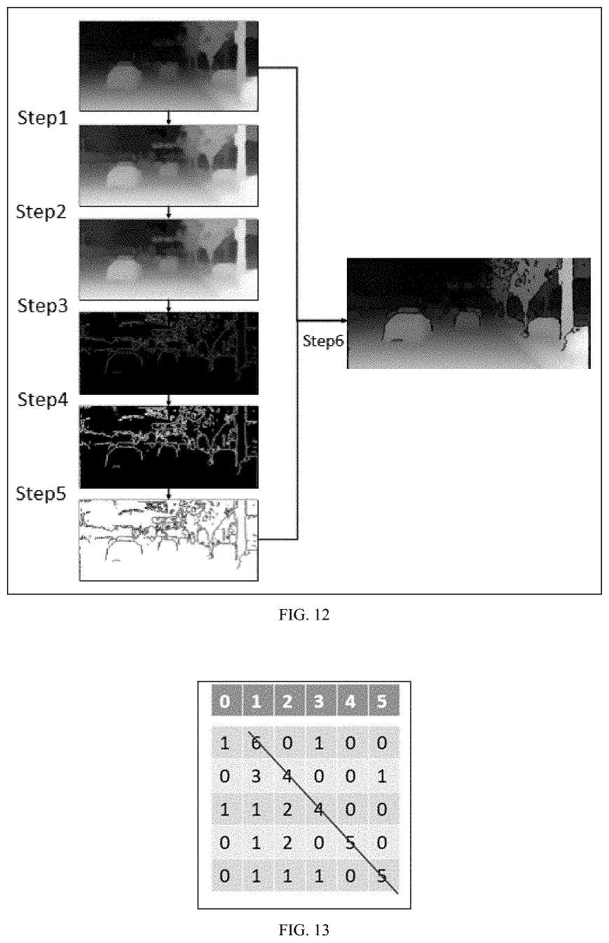

In an optional example, the method for obtaining the obstacle edge information in the first disparity map of the environment image in the disclosure includes, but is not limited to, that: the obstacle edge information of the first disparity map of the environment image is obtained by using the CNN for edge extraction; and the obstacle edge information of the first disparity map of the environment image is obtained by using an edge detection algorithm. Optionally, an implementation mode of using the edge detection algorithm to obtain the obstacle edge information of the first disparity map of the environment image in the disclosure is shown in FIG. 12.

In FIG. 12, at S1, histogram equalization is performed on the first disparity map of the environment image. The first disparity map of the environment image is the image in the upper left corner of FIG. 12. The first disparity map may finally obtain the first disparity map of the environment image shown in FIG. 2 by the above S100. The result of histogram equalization is shown in the second figure on the top left of FIG. 12.

At S2, mean filtering is performed on the result of histogram equalization. The result of filtering is shown in the third figure on the top left of FIG. 12. S1 and S2 are preprocessing of the first disparity map of the environment image. S1 and S2 are only an example of preprocessing the first disparity map of the environment image. The disclosure does not limit the specific implementation mode of preprocessing.

At S3, edge detection is performed on the result of filtering by using the edge detection algorithm, and edge information is obtained. The edge information obtained in this step is shown in the fourth figure on the top left of FIG. 12. The edge detection algorithms in the disclosure include, but are not limited to: Canny edge detection algorithm, Sobel edge detection algorithm or Laplacian edge detection algorithm, etc.

At S4, morphological dilation operation is performed on the obtained edge information. The result of dilation operation is shown in the fifth figure on the top left of FIG. 12. This step is a post processing mode for a detection result of the edge detection algorithm. The disclosure does not limit the specific implementation mode of post processing.

At S5, reverse operation is performed on the result of dilation operation to obtain an edge mask of the first disparity map of the environment image. The edge mask of the first disparity map of the environment image is shown in the figure on the bottom left of FIG. 12.

At S6, an AND operation is performed on the edge mask of the first disparity map of the environment image and the first disparity map of the environment image to obtain the obstacle edge information in the first disparity map of the environment image. On the right side of FIG. 12, the obstacle edge information in the first disparity map of the environment image is shown. For example, the disparity value at the edge of the obstacle in the first disparity map of the environment image is set as 0. The obstacle edge information is shown as black edge line in FIG. 12.

In an optional example, an example of determining the obstacle area in the first disparity map of the disclosure includes the following steps.

At Step a, statistical analysis is performed on the disparity values of each row of pixels in the first disparity map, and statistical information of the disparity values of each row of pixels is obtained; and a statistical disparity map is determined based on the statistical information of the disparity values of each row of pixels.

Optionally, the disclosure may perform transverse statistics (row direction statistics) to the first disparity map of the environment image to obtain a V disparity map, which may be taken as a statistical disparity map. That is, for each row of the first disparity map of the environment image, the number of disparity values in the row is counted, and the statistical result is set on the corresponding column of the V disparity map. The width of the V disparity map (that is, the number of columns) is related to the value range of the disparity value. For example, if the value range of the disparity value is 0-254, then the width of the V disparity map is 255. The height of the V disparity map is the same as the height of the first disparity map of the environment image, that is, both contain the same number of rows. Optionally, for the first disparity map of the environment image shown in FIG. 4, the statistical disparity map formed by the disclosure is shown in FIG. 13. In FIG. 13, the top row represents the disparity values 0 to 5. The value at the second row and the first column is 1, indicating that the number of disparity values of 0 in the first row of FIG. 4 is 1. The value at the second row and the second column is 6, indicating that the number of disparity values of 1 in the first row of FIG. 4 is 6. The value at the fifth row and the sixth column is 5, indicating that the number of disparity values of 5 in the fifth row of FIG. 4 is 5. The other values in FIG. 13 are not described here individually.

Optionally, for the first disparity map of the environment image shown in the left figure in FIG. 14, the first disparity of the environment image is processed, and the obtained V disparity is shown in the right figure in FIG. 14.

At Step b, first linear fitting is performed on the statistical disparity map (also called the V disparity map in the disclosure), and a ground area and a non-ground area are determined according to a result of the first linear fitting.

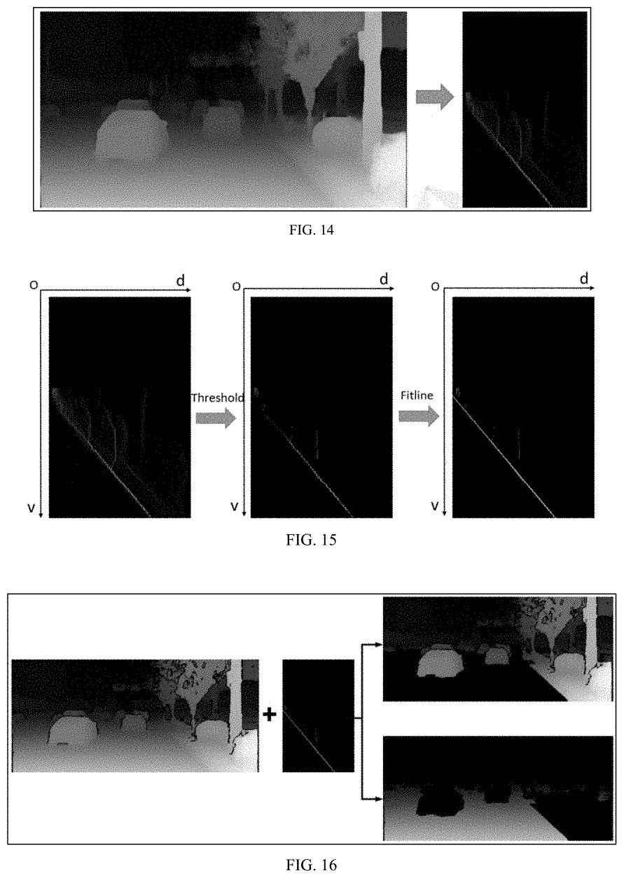

First, the V disparity map may be preprocessed in the disclosure. The preprocessing to the V disparity map may include, but may not be limited to, noise removal. For example, threshold filtering (threshold) is performed on the V disparity map to filter the noise in the V disparity map. When the V disparity map is shown in the first figure on the left of FIG. 15, the V disparity map after noise removal is shown in the second figure on the left of FIG. 15.

Secondly, the first linear fitting (fitline) is performed for the V disparity map after noise removal to obtain a first linear equation V=Ad+B. v represents the row coordinate in the V disparity map, and d represents the disparity value.

For example, the diagonal line in FIG. 13 represents the fitted first linear equation. For another example, the white slash in the first figure on the right of FIG. 15 represents the fitted first linear equation. The first linear fitting mode includes, but is not limited to, the RANSAC linear fitting mode.

Optionally, the first linear equation obtained by fitting may represent a relationship between the disparity value of the ground area and the row coordinate of the V disparity map. That is, for any row in the V disparity map, the disparity value d of the ground area should be a determined value in case of the determined v. The disparity value of the ground area may be expressed in the form of formula (6) below:

$${d}_{road} = \frac{v - B}{A} . \qquad ( 6 )$$

In the formula (6), d_{road} represents the disparity value of the ground area, A and B are known values, such as the values obtained through the first linear fitting.

Thirdly, the disclosure may use formula (6) to segment the first disparity map of the environment image, so as to obtain the ground area I_{road} and the non-ground area I_{notroad}.

Optionally, the disclosure may use the following formula (7) to determine the ground area and the non-ground area.

$$\{ \begin{matrix}{I}_{road} = I ( \vert d - {d}_{road} \vert \leq thresh 3 ) \\ {I}_{notroad} = I ( \vert d - {d}_{road} \vert > thresh 3 )\end{matrix} . \qquad ( 7 )$$

In the formula (7), I(*) represents a pixel set; if the disparity value of a pixel in the first disparity map of the environment image satisfies |d−d_{road}|≤thresh3, then the pixel belongs to the ground area I_{road}; if the disparity value of a pixel in the first disparity map of the environment image satisfies |d−d_{road}|>thresh3 the pixel belongs to the non-ground area; thresh3 represents a threshold, which is a known value. The threshold may be set according to the actual situation.

Optionally, the ground area I_{road} may be shown in the upper right figure of FIG. 16. The non-ground area I_{notroad} may be shown in the lower right figure of FIG. 16. By setting a threshold, the disclosure is conducive to removing the influence of noise in the first disparity map of the environment image on area determination, thus facilitating the more accurate determination of ground and non-ground areas.

Finally, the obstacle area is determined according to the non-ground area.

Optionally, the non-ground area I_{notroad} in the disclosure may include: at least one of a first area I_{high} above the ground and a second area I_{low} below the ground. The disclosure may take an area above the ground, whose height above the ground is less than a predetermined height value, in the non-ground area I_{notroad} as the obstacle area. Because the area I_{low} below the ground may be a pit, a ditch or a valley, etc., the disclosure may take an area below the ground, whose height below the ground is less than a predetermined height value, in the non-ground area I_{notroad} as the obstacle area.

The first area I_{high} above the ground and the second area I_{low} below the ground in the disclosure may be represented by the following formula (8):

$$\{ \begin{matrix}{I}_{high} = {I}_{notroad} ( d - {d}_{road} > thresh 4 ) \\ {I}_{low} = {I}_{notroad} ( {d}_{road} - d > thresh 4 )\end{matrix} . \qquad ( 8 )$$

In the formula (8), I_{notroad}(*) represents a pixel set; if the disparity value of a pixel in the first disparity map of the environment image satisfies d−d_{road}>thresh4, then the pixel belongs to the first area I_{high} above the ground; if the disparity value of a pixel in the first disparity map of the environment image satisfies d_{road}−d>thresh4, the pixel belongs to the second area I_{low} below the ground; thresh4 represents a threshold, which is a known value. The threshold may be set according to the actual situation.

Optionally, the first area I_{high} above the ground often includes obstacles that do not need to be paid attention to, such as traffic lights, overpasses and other target objects. Because they will not affect the driving of vehicles, these target objects are obstacles that do not need to be paid attention to for vehicles. These obstacles that do not need to be paid attention to are often at high positions, which will not affect the driving of vehicles and the walking of pedestrians. The disclosure may remove an area at a higher position from the first area I_{high} above the ground, for example, remove the area whose height above the ground is greater than or equal to the first predetermined height value to form the obstacle area I_{obstacle}.

Optionally, the disclosure may perform a second linear fitting according to the V disparity map, and may determine the area at a higher position that needs to be removed in the non-ground area (that is, the area whose height above the ground is greater than or equal to the first predetermined height value), so as to obtain the obstacle area I_{obstacle} in the non-ground area. The second linear fitting mode includes, but is not limited to, the RANSAC linear fitting mode. Optionally, when there is a second area below the ground in the non-ground area, a second target area, whose height below the ground is greater than a second predetermined height value, in the second area is determined. The second target area is the obstacle area. The disclosure performs the second linear fitting for the V disparity map, so the obtained second linear equation may be expressed as v=Cd+D, where v represents the row coordinate in the V disparity map, and d represents the disparity value. Through derivation and calculation, C and D may be expressed as:

$$C = \frac{AH}{Ab + H} , \\ D = \frac{ABb ( B - {c}_{y} )}{Ab + H} ,$$

so the second linear equation in the disclosure may be expressed as:

$$v = \frac{AH}{Ab + H} d + \frac{ABb ( B - {c}_{y} )}{Ab + H} ,$$

where H is a known constant value, and H may be set according to actual needs. For example, in the intelligent control technology of vehicles, H may be set to 2.5 meters.

Optionally, the middle image in FIG. 18 includes upper and lower white slashes, and the upper white slash represents the fitted second linear equation.

Optionally, the second linear equation obtained by fitting may represent a relationship between the disparity value of the obstacle area and the row coordinate of the V disparity map. That is, for any row in the V disparity map, the disparity value d of the obstacle area should be a determined value in case of the determined v.

Optionally, the disclosure may divide the first area I_{high} above the ground into the form expressed in the following formula (9):

$$\{ \begin{matrix}{I}_{< H} = {I}_{high} ( d < {d}_{H} ) \\ {I}_{> H} = {I}_{high} ( d > {d}_{H} )\end{matrix} . \qquad ( 9 )$$

In the above formula (9), I_{high}(*) represents a pixel set; if the disparity value d of a pixel in the first disparity map of the environment image satisfies d<d_{H}, the pixel belongs to the area I_{<H} which is above the ground but below a height H above the ground; the disclosure may take I_{<H} as the obstacle area I_{obstacle}; if the disparity value d of a pixel in the first disparity map of the environment image satisfies d>d_{H}, the pixel belongs to the area I_{>H} that is above the ground and above the ground at the height H; d_{H} represents the disparity value of the pixel at the height H above the ground; I_{>H} may be shown in the upper right figure of FIG. 18. I_{<H} may be shown in the lower right figure of FIG. 18. In the above formula (9),

$${d}_{H} = \frac{v - D}{C} .$$

In an optional example, the method of determining a pixel columnar area in the obstacle area I_{obstacle} according to the obstacle edge information in the disclosure may be that: first, the disparity value of the pixel of the non-obstacle area in the first disparity map and the disparity value of the pixel at the obstacle edge information are set as a predetermined value; secondly, taking N pixels in the column direction of the first disparity map as a traversal unit, the disparity values of N pixels in each row are traversed from the set row of the first disparity map, and a target row where the disparity value of the pixel has a jump between the predetermined value and a non-predetermined value is determined; and finally, the obstacle pixel columnar area in the obstacle area is determined by taking N pixels in the column direction as a column width, and taking the determined target row as the boundary of the obstacle pixel columnar area in the row direction. For example, the method of determining the pixel columnar area in the obstacle area I_{obstacle} according to the obstacle edge information in the disclosure may be that: first, the disparity values at the edge position of the obstacle in the disparity map are all set as the predetermined value (e.g., 0) according to the detected obstacle edge information, and the disparity values in the area except the obstacle area in the disparity map are also set as the predetermined value (e.g., 0); then, according to a predetermined column width (the width of at least one column of pixels, such as the width of 6 columns of pixels), upward searching is started from the very bottom of the disparity map, and when it is searched that the disparity value of any column of pixels in the predetermined column width jumps from a predetermined value to a non-predetermined value, the position (the row of the disparity map) is determined as the bottom of the pixel columnar area and the forming of the pixel columnar area is started, that is, the upward extension of the pixel columnar area is started. For example, the searching of a jump from the non-predetermined value to the predetermined value in the disparity map is continued; when it is searched that the disparity value of any column of pixels in the predetermined column width jumps from the non-predetermined value to the predetermined value, the upward extension of the pixel columnar area is stopped, and the position (the row of the disparity map) is determined as the top of the pixel columnar area, thus forming an obstacle pixel columnar area.

It is to be particularly noted that the disclosure can start the process of determining the obstacle pixel columnar area from the lower left corner of the disparity map until the lower right corner of the disparity map. For example, the process of determining the obstacle pixel columnar area is started from the leftmost 6 columns of the disparity map, and then the process of determining the obstacle pixel columnar area is started from the leftmost 7th to 12th columns of the disparity map until the rightmost column of the disparity map. The disclosure may also start the process of determining the obstacle pixel columnar area from the lower right corner of the disparity map until the lower left corner of the disparity map. In addition, it is also perfectly feasible to extend from the middle of the lowest part of the disparity map to the two sides to form the obstacle pixel columnar area.

In an optional example, the method of forming the pixel columnar area in the obstacle area I_{obstacle} according to the obstacle edge information in the disclosure may be that: first, the disparity values at the edge position of the obstacle in the disparity map are all set as the predetermined value (e.g., 0) according to the detected obstacle edge information, and the disparity values in the area except the obstacle area in the disparity map are also set as the predetermined value (e.g., 0); then, according to a predetermined column width (the width of at least one column of pixels, such as the width of 6 columns of pixels), downward searching is started from the very top of the disparity map, and when it is searched that the disparity value of any column of pixels in the predetermined column width jumps from a predetermined value to a non-predetermined value, the position (the row of the disparity map) is determined as the top of the pixel columnar area and the forming of the pixel columnar area is started, that is, the downward extension of the pixel columnar area is started. For example, the searching of a jump from the non-predetermined value to the predetermined value in the disparity map is continued; when it is searched that the disparity value of any column of pixels in the predetermined column width jumps from the non-predetermined value to the predetermined value, the downward extension of the pixel columnar area is stopped, and the position (the row of the disparity map) is determined as the bottom of the pixel columnar area, thus forming an obstacle pixel columnar area. It is to be particularly noted that the disclosure can start the process of determining the obstacle pixel columnar area from the upper left corner of the disparity map until the upper right corner of the disparity map. For example, the process of determining the obstacle pixel columnar area is started from the leftmost 6 columns on top of the disparity map, and then the process of determining the obstacle pixel columnar area is started from the leftmost 7th to 12th columns on top of the disparity map until the rightmost column of the disparity map. The disclosure may also start the process of determining the obstacle pixel columnar area from the upper right corner of the disparity map until the upper left corner of the disparity map. In addition, it is also perfectly feasible to extend from the middle of the uppermost part of the disparity map to the two sides to form the obstacle pixel columnar area.

Optionally, an example of the obstacle pixel columnar area formed for the environment image in FIG. 2 is shown in the right figure of FIG. 19. The width of each obstacle pixel columnar area in the right figure of FIG. 19 is the width of 6 columns of pixels. The width of the obstacle pixel columnar area may be set according to the actual needs. The wider the obstacle pixel columnar area is set, the rougher the obstacle pixel columnar area is formed, and the shorter the time of forming the obstacle pixel columnar area is consumed.

In an optional example, after the obstacle pixel columnar area is formed, attribute information of the obstacle pixel columnar area should be determined. The attribute information of the obstacle pixel columnar area includes, but is not limited to: spatial location information of the obstacle pixel columnar area, bottom information (bottom) of the obstacle pixel columnar area, disparity value (disp) of the obstacle pixel columnar area, top information (top) of the obstacle pixel columnar area and column information (col) of the obstacle pixel columnar area.

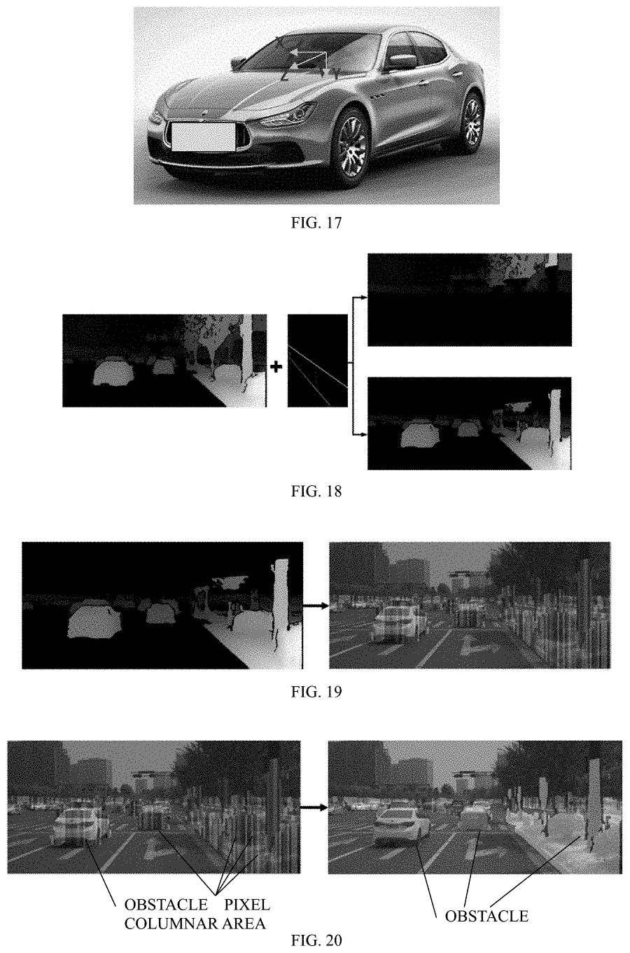

Optionally, the spatial location information of the obstacle pixel columnar area may include: the coordinate of the obstacle pixel columnar area on the horizontal coordinate axis (X axis), the coordinate of the obstacle pixel columnar area on the depth coordinate axis (Z axis), the highest point coordinate of the obstacle pixel columnar area on the vertical coordinate axis (Y axis) and the lowest point coordinate of the obstacle pixel columnar area on the vertical coordinate axis (Y axis). That is, the spatial location information of the obstacle pixel columnar area includes: X coordinate, Z coordinate, the maximum Y coordinate and the minimum Y coordinate of the obstacle pixel columnar area. An example of the X axis, the Y axis and the Z axis is shown in FIG. 17.

Optionally, the bottom information of the obstacle pixel columnar area may be the row number at the bottom of the obstacle pixel columnar area. When the predetermined value is 0, the disparity value of the obstacle pixel columnar area may be the disparity value of the pixel at a non-zero position when the disparity value jumps from zero to non-zero. The top information of the obstacle pixel columnar area may be the row number of the pixel at a zero position when the disparity value jumps from non-zero to zero. The column information of the obstacle pixel columnar area may be the column number of any one of all the columns included the pixel of the apparatus, for example, the column number of a column located in the middle of the pixel columnar area.

Optionally, for each obstacle pixel columnar area, in the disclosure, the spatial location information of the obstacle pixel columnar area is calculated by using the following formula (10), that is, the X coordinate, the Z coordinate, the maximum Y coordinate and the minimum Y coordinate of the obstacle pixel columnar area:

$$\{ \begin{matrix}Z = \frac{fb}{Disp} \\ X = \frac{Z ( Col - {c}_{x} )}{f}\end{matrix} . \qquad ( 10 )$$

In the above formula (10), b represents the spacing between the binocular camera devices, f represents the focal length of the camera device, Disp represents the disparity value of the obstacle pixel columnar area, Col represents the column information of the obstacle pixel columnar area, and cₓ represents the X coordinate value of the main point of the camera device.

Optionally, the Y coordinate of each pixel in the obstacle pixel columnar area may be expressed by the following formula (11):

$${Y}_{i} = \frac{Z ( {row}_{i} - {c}_{y} )}{f} . \qquad ( 11 )$$

In the above formula (11), Yᵢ represents the Y coordinate of the i-th pixel in the obstacle pixel columnar area, rowᵢ represents the row number of the i-th pixel in the obstacle pixel columnar area, c_{y} represents the Y coordinate value of the main point of the camera device, Z represents the Z coordinate of the obstacle pixel columnar area, and f represents the focal length of the camera device.

After the Y coordinates of all the pixels in an obstacle pixel columnar area are obtained, the maximum Y coordinate and the minimum Y coordinate may be obtained. The maximum Y coordinate and the minimum Y coordinate may be expressed by the following formula (12):

Yₘᵢₙ=min(Yᵢ)

Yₘₐₓ=max(Yᵢ) (12).

In the above formula (12), Yₘᵢₙ represents the minimum Y coordinate of the obstacle pixel columnar area, Yₘₐₓ represents the maximum Y coordinate of the obstacle pixel columnar area, min(Yᵢ) represents the minimum value of all the calculated Yᵢ, and max(Yᵢ) represents the maximum value of all the calculated Yᵢ.

At S120, multiple obstacle pixel areas are clustered to obtain at least one class cluster.

In an optional example, the disclosure may cluster multiple obstacle pixel columnar areas to obtain at least one class cluster. The disclosure may cluster all the obstacle pixel columnar areas according to the spatial location information of the obstacle pixel columnar area. A class cluster corresponds to an obstacle example. The disclosure may cluster the obstacle pixel columnar areas by using a corresponding clustering algorithm.

Optionally, before multiple obstacle pixel columnar areas are clustered, the X coordinate and the Z coordinate of the obstacle pixel columnar area may be normalized (that is, normalization).

For example, the disclosure may use a min-max normalization method to map the X coordinate and the Z coordinate of the obstacle pixel columnar area, so that the X coordinate and the Z coordinate of the obstacle pixel columnar area are mapped to the value range of [0-1]. An example of the normalization method is expressed by the following formula (13):

$$\{ \begin{matrix}{X}^{*} = \frac{X - {X}_{min}}{{X}_{max} - {X}_{min}} \\ {Z}^{*} = \frac{Z - {Z}_{min}}{{Z}_{max} - {Z}_{min}}\end{matrix} . \qquad ( 13 )$$

In the above formula (13), x* represents the X coordinate after normalization, Z* represents the Z coordinate after normalization, X represents the X coordinate of the obstacle pixel columnar area, Z represents the Z coordinate of the obstacle pixel columnar area, Xₘᵢₙ represents the minimum value in the X coordinates of all the obstacle pixel columnar areas, Xₘₐₓ represents the maximum value in the X coordinates of all the obstacle pixel columnar areas, Zₘᵢₙ represents the minimum value in the Z coordinates of all the obstacle pixel columnar areas, and Zₘₐₓ represents the maximum value in the Z coordinates of all the obstacle pixel columnar areas.

For another example, the disclosure may also use a Z-score normalization method to normalize the X coordinate and the Y coordinate of the obstacle pixel columnar area. An example of the normalization method is expressed by the following formula (14):

$$\{ \begin{matrix}{X}^{*} = \frac{X - {μ}_{X}}{{σ}_{X}} \\ {Z}^{*} = \frac{Z - {μ}_{Z}}{{σ}_{Z}}\end{matrix} . \qquad ( 14 )$$

In the above formula (14), X* represents the X coordinate after normalization, Z* represents the Z coordinate after normalization, X represents the X coordinate of the obstacle pixel columnar area, Z represents the Z coordinate of the obstacle pixel columnar area, μ_{X} represents a mean value calculated for the X coordinates of all the obstacle pixel columnar areas, σ_{X} represents a standard deviation calculated for the X coordinates of all the obstacle pixel columnar areas, μ_{Z} represents a mean value calculated for the Z coordinates of all the obstacle pixel columnar areas, and σ_{Z} represents a standard deviation calculated for the Z coordinates of all the obstacle pixel columnar areas. Both X* and Z* of all the obstacle pixel columnar areas after the processing of the disclosure conform to the standard normal distribution, that is, the mean value is 0 and the standard deviation is 1.

Optionally, the disclosure may use a Density-Based Spatial Clustering of Applications with Noise (DBSCAN) algorithm to cluster the obstacle pixel columnar areas according to the spatial location information of all the obstacle pixel columnar areas after normalization, thus forming at least one class cluster. Each class cluster is an obstacle example. The disclosure does not limit the clustering algorithm. An example of clustering result is shown in the right figure of FIG. 20.

At S130, an obstacle detection result is determined according to the obstacle pixel areas belonging to the same class cluster.

Exemplarily, the obstacle detection result, for example, may include but may not be limited to at least one of an obstacle bounding-box and spatial location information of the obstacle.

In an optional example, the disclosure may determine the obstacle bounding-box in the environment image according to the spatial location information of the obstacle pixel columnar areas belonging to the same class cluster. For example, for a class cluster, the disclosure may calculate the maximum column coordinate uₘₐₓ and the minimum column coordinate min uₘᵢₙ the environment image of all the obstacle pixel columnar areas in the class cluster, and calculate the maximum bottom (that is, vₘₐₓ) and the minimum top (that is, vₘᵢₙ) of all the obstacle pixel columnar areas in the class cluster (note: it is assumed that the origin of an image coordinate system is at the upper left corner of the image). The coordinates of the obstacle bounding-box obtained by the disclosure in the environment image may be expressed as (uₘᵢₙ, vₘᵢₙ, uₘₐₓ, vₘₐₓ). Optionally, an example of the determined obstacle bounding-box in the disclosure is shown in the right figure of FIG. 21. All the multiple rectangular boxes in the right figure of FIG. 21 are the obstacle bounding-boxes obtained by the disclosure.

In the disclosure, the obstacle is obtained by clustering multiple obstacle pixel columnar areas, it is not necessary to predefine the obstacle to be detected, and the obstacle can be directly detected by clustering the obstacle areas without using any predefined information of the obstacle, such as texture, color, shape and category, and the detected obstacles are not limited to some predefined obstacles. The disclosure may detect a variety of obstacles that may hinder the moving process of the intelligent device in the surrounding environment, thereby realizing the detection of generic obstacles.

In an optional example, the disclosure may also determine the spatial location information of the obstacle according to the spatial location information of multiple obstacle pixel columnar areas belonging to the same class cluster. The spatial location information of the obstacle may include, but may not be limited to: the coordinate of the obstacle on the horizontal coordinate axis (X axis), the coordinate of the obstacle on the depth coordinate axis (Z axis), and the height of the obstacle in the vertical direction (i.e. the height of the obstacle), etc. Optionally, the disclosure may first determine distances between multiple obstacle pixel columnar areas in the class cluster and the camera device generating the environment image according to the spatial location information of the multiple obstacle pixel columnar areas belonging to the same class cluster, and then determine the spatial location information of the obstacle according to the spatial location information of the obstacle pixel columnar area that is closest to the camera device.

Optionally, the disclosure may use the following formula (15) to calculate the distances between multiple obstacle pixel columnar areas in a class cluster and the camera device, and select the minimum distance.

dₘᵢₙ=min(\sqrt{Xᵢ²+Zᵢ²}) (15).

In the above formula (15), dₘᵢₙ represents the minimum distance, Xᵢ represents the X coordinate of the i-th obstacle pixel columnar area in a class cluster, and Zᵢ represents the Z coordinate of the i-th obstacle pixel columnar area in a class cluster.

After the minimum distance is determined, the X coordinate and the Z coordinate of the obstacle pixel columnar area with the minimum distance may be taken as the spatial location information of the obstacle, as shown in the following formula (16):

O_{X}=X_{close}

O_{Z}=Z_{close} (16).

In the above formula (16), O_{X} represents the coordinate of the obstacle on the horizontal coordinate axis, namely the X coordinate of the obstacle, O_{Z} represents the coordinate of the obstacle on the depth coordinate axis (X axis), namely the Z coordinate of the obstacle, X_{close} represents the X coordinate of the calculated obstacle pixel columnar area with the minimum distance, and Z_{close} represents the Z coordinate of the calculated obstacle pixel columnar area with the minimum distance.

Optionally, the disclosure may use the following formula (17) to calculate the height of the obstacle:

O_{H}=Yₘₐₓ−Yₘᵢₙ (17).

In the above formula (17), O_{H} represents the height of the obstacle, Yₘₐₓ represents the maximum Y coordinate of all the obstacle pixel columnar areas in a class cluster, and Yₘᵢₙ represents the minimum Y coordinate of all the obstacle pixel columnar areas in a class cluster.

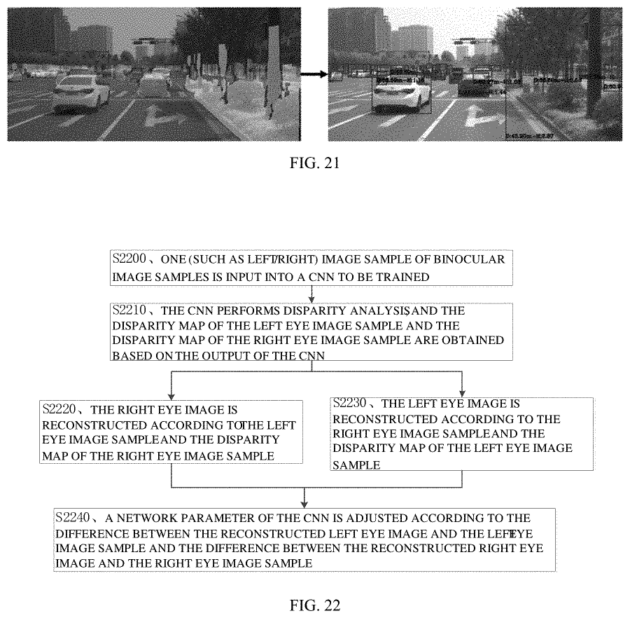

A process of an implementation mode of training a CNN is shown in FIG. 22.

At S2200, one (such as left/right) image sample of binocular image samples is input into a CNN to be trained.

Optionally, in the disclosure, the image sample input into the CNN may always be the left eye image sample of the binocular image samples or the right eye image sample of the binocular image samples. When the image sample input into the CNN is always the left eye image sample of the binocular image samples, the successfully trained CNN will take the input environment image as the left eye image in a test or actual application scenario. When the image sample input into the CNN is always the right eye image sample of the binocular image samples, the successfully trained CNN will take the input environment image as the right eye image in a test or actual application scenario.

At S2210, the CNN performs disparity analysis, and the disparity map of the left eye image sample and the disparity map of the right eye image sample are obtained based on the output of the CNN.

At S2220, the right eye image is reconstructed according to the left eye image sample and the disparity map of the right eye image sample.

Optionally, the method of reconstructing the right eye image sample in the disclosure includes but is not limited to that: re-projection calculation is performed on the disparity map of the right eye image sample and the left eye image sample to obtain the reconstructed right eye image.

At S2230, the left eye image is reconstructed according to the right eye image sample and the disparity map of the left eye image sample.

Optionally, the method of reconstructing the left eye image sample in the disclosure includes but is not limited to that: re-projection calculation is performed on the disparity map of the left eye image sample and the right eye image sample to obtain the reconstructed left eye image.

At S2240, a network parameter of the CNN is adjusted according to the difference between the reconstructed left eye image and the left eye image sample and the difference between the reconstructed right eye image and the right eye image sample.

Optionally, when the difference is determined in the disclosure, the loss functions used include, but are not limited to: L1 loss function, smooth loss function and lr-Consistency loss function, etc. In addition, when the calculated loss is back propagated to adjust the network parameters (such as the weight value of a convolution kernel) of the CNN in the disclosure, the loss may be back propagated based on a gradient calculated by the chain derivation of the CNN, which is conducive to improving the training efficiency of the CNN.

In an optional example, when the training for the CNN achieves a predetermined iteration condition, the training process is completed. The predetermined iteration condition in the disclosure may include that: the difference between the left eye image reconstructed based on the disparity map output by the CNN and the left eye image sample, and the difference between the right eye image reconstructed based on the disparity map output by the CNN and the right eye image sample meet a predetermined difference requirement. When the difference meets the requirement, the CNN is successfully trained this time. The predetermined iteration condition in the disclosure may also include that: the number of binocular image samples used for training the CNN meets a predetermined number requirement. When the number of binocular image samples used meets the predetermined number requirement, but the difference between the left eye image reconstructed based on the disparity map output by the CNN and the left eye image sample, and the difference between the right eye image reconstructed based on the disparity map output by the CNN and the right eye image sample do not meet the predetermined difference requirement, the CNN is not successfully trained this time.

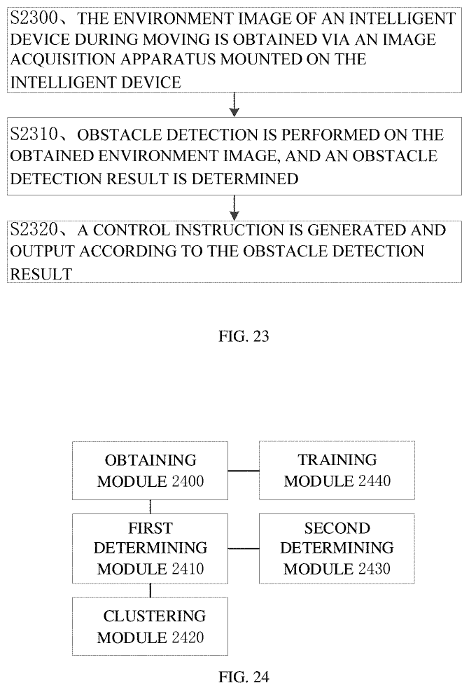

FIG. 23 is a flowchart of an embodiment of an intelligent driving control method according to the disclosure. The intelligent driving control method of the disclosure may be applied to, but is not limited to: an autonomous driving (such as completely unassisted autonomous driving) environment or an assisted driving environment.

At S2300, the environment image of an intelligent device during moving is obtained via an image acquisition apparatus mounted on the intelligent device. The image acquisition apparatus includes, but is not limited to: a camera device based on RGB, etc.

At S2310, obstacle detection is performed on the obtained environment image, and an obstacle detection result is determined. The description for FIG. 1 in the method embodiment above may be taken as a reference for the detailed implementation process of this step which will not be described in detail here.

At S2320, a control instruction is generated and output according to the obstacle detection result.

Optionally, the control instructions generated in the disclosure include, but are not limited to: a speed keeping control instruction, a speed adjustment control instruction (e.g., an instruction of reducing speed and an instruction of speeding up), a direction keeping control instruction, a direction adjustment control instruction (e.g., an instruction of turning left, an instruction of turning right, an instruction of merging to the left lane, or an instruction of merging to the right lane), a honking instruction, a warning prompt control instruction or a driving mode switching control instruction (e.g., an instruction of switching to automatic cruise driving mode).

It is to be particularly noted that the obstacle detection technology of the disclosure may also be applied in other fields in addition to being applicable to the field of intelligent driving control. For example, the obstacle detection in industrial manufacturing, the obstacle detection in indoor fields such as supermarket, the obstacle detection in security field, etc. may be realized, and the applicable scenario of the obstacle detection technology of the disclosure is not limited.

FIG. 24 is a structural schematic diagram of an embodiment of an obstacle detection apparatus according to the disclosure. The apparatus in FIG. 24 may include: an obtaining module 2400, a first determining module 2410, a clustering module 2420, a second determining module 2430 and a training module 2440.

The obtaining module 2400 is configured to obtain the first disparity map of the environment image. The environment image is an image representing information of a space environment where an intelligent device is moving. Optionally, the environment image includes the monocular image. The obtaining module 2400 may include: a first sub-module, a second sub-module and a third sub-module. The first sub-module is configured to use the CNN to perform disparity analysis to the monocular image, and to obtain the first disparity map of the monocular image based on an output of the CNN. The CNN is trained with the binocular image samples. The second sub-module is configured to, by mirroring the monocular image in the environment image, obtain the first mirror image, and obtain the disparity map of the first mirror image. The third sub-module is configured to, according to the disparity map of the first mirror image, perform disparity adjustment on the first disparity map of the monocular image to obtain the first disparity map subjected to disparity adjustment. The third sub-module may include: a first unit and a second unit. The first unit is configured to, after mirroring the disparity map of the first mirror image, obtain the second mirror image. The second unit is configured to, according to the weight distribution map of the first disparity map and the weight distribution map of the second mirror image, perform disparity adjustment on the first disparity map to obtain the first disparity map subjected to disparity adjustment. The weight distribution map of the first disparity map includes weight values corresponding respectively to multiple disparity values in the first disparity map, and the weight distribution map of the second mirror image includes weights corresponding respectively to multiple disparity values in the second mirror image.

Optionally, the weight distribution map in the disclosure includes at least one of a first weight distribution map and a second weight distribution map. The first weight distribution map is a weight distribution map uniformly set for multiple environment images. The second weight distribution map is a weight distribution map respectively set for different environment images. The first weight distribution map includes at least two areas separated to the left and right, and different areas have different weight values.

Optionally, when the monocular image is the left eye image, for any two areas in the first weight distribution map of the first disparity map, the weight value of the area on the right is not less than the weight value of the area on the left; for any two areas in the first weight distribution map of the second mirror image, the weight value of the area on the right is not less than the weight value of the area on the left. For at least one area in the first weight distribution map of the first disparity map, the weight value of the left part of the area is not greater than the weight value of the right part of the area. For at least one area in the first weight distribution map of the second mirror image, the weight value of the left part of the area is not greater than the weight value of the right part of the area.

Optionally, when the monocular image is the right eye image, for any two areas in the first weight distribution map of the first disparity map, the weight value of the area on the left is not less than the weight value of the area on the right; for any two areas in the first weight distribution map of the second mirror image, the weight value of the area on the left is not less than the weight value of the area on the right.

Optionally, for at least one area in the first weight distribution map of the first disparity map, the weight value of the right part of the area is not greater than the weight value of the left part of the area. For at least one area in the first weight distribution map of the second mirror image, the weight value of the right part of the area is not greater than the weight value of the left part of the area.

Optionally, the third sub-module may also include: a third unit, configured to set the second weight distribution map of the first disparity map. Specially, the third unit mirrors the first disparity map to form a mirror disparity map, and sets the weight value in the second weight distribution map of the first disparity map according to the disparity value in the mirror disparity map of the first disparity map. For example, for the pixel at any position in the mirror disparity map, if the disparity value of the pixel at the position satisfies the first predetermined condition, the third unit sets the weight value of the pixel at the position in the second weight distribution map of the first disparity map as a first value. If the disparity value of the pixel does not satisfy the first predetermined condition, the third unit may set the weight value of the pixel at the position in the second weight distribution map of the first disparity map as a second value. The first value is greater than the second value. The first predetermined condition may include that: the disparity value of the pixel at the position is greater than a first reference value of the pixel at the position. The first reference value of the pixel at the position is set according to the disparity value of the pixel at the position in the first disparity map and a constant value that is greater than zero.

Optionally, the third sub-module may also include a fourth unit. The fourth unit is configured to set the second weight distribution map of the second mirror image. For example, the fourth unit sets the weight value in the second weight distribution map of the second mirror image according to the disparity value in the first disparity map. More specifically, for the pixel at any position in the second mirror image, if the disparity value of the pixel at the position in the first disparity map satisfies a second predetermined condition, the fourth unit sets the weight value of the pixel at the position in the second weight distribution map of the second mirror image as a third value. If the disparity value of the pixel at the position in the first disparity map does not satisfy the second predetermined condition, the fourth unit sets the weight value of the pixel at the position in the second weight distribution map of the second mirror image as a fourth value. The third value is greater than the fourth value. The second predetermined condition includes that: the disparity value of the pixel at the position in the first disparity map is greater than a second reference value of the pixel at the position. The second reference value of the pixel at the position is set according to the disparity value of the pixel at the position in the mirror disparity map of the first disparity map and a constant value that is greater than zero.

Optionally, the second unit may adjust the disparity value in the first disparity map according to the first weight distribution map and the second weight distribution map of the first disparity map, and may adjust the disparity value in the second mirror image according to the first weight distribution map and the second weight distribution map of the second mirror image. The second unit combines the first disparity map subjected to disparity adjustment and the second mirror image subjected to disparity value adjustment to finally obtain the first disparity map subjected to disparity adjustment.

The description for S100 in the above method embodiment may be taken as a reference for the specific operations performed by the parts included in the obtaining module 2400, which will not be described in detail here.

The first determining module 2410 is configured to determine multiple obstacle pixel areas in the first disparity map of the environment image. The first determining module 2410 may include: a fourth sub-module, a fifth sub-module and a sixth sub-module. The fourth sub-module is configured to perform edge detection on the first disparity map of the environment image, and to obtain the obstacle edge information. The fifth sub-module is configured to determine the obstacle area in the first disparity map of the environment image. The sixth sub-module is configured to determine multiple obstacle pixel columnar areas in the obstacle area of the first disparity map according to the obstacle edge information. The fifth sub-module may include: a fifth unit, a sixth unit, a seventh unit and an eighth unit. The fifth unit is configured to perform statistical analysis on the disparity values of each row of pixels in the first disparity map, and to obtain statistical information of the disparity values of each row of pixels. The sixth unit is configured to determine a statistical disparity map based on the statistical information of the disparity values of each row of pixels. The seventh unit is configured to perform first linear fitting on the statistical disparity map, and to determine the ground area and the non-ground area according to the result of the first linear fitting. The eighth unit is configured to determine the obstacle area according to the non-ground area. The non-ground area includes: the first area above the ground. The non-ground area includes: the first area above the ground and the second area below the ground. The eighth unit may perform the second linear fitting on the statistical disparity map, and according to the result of the second linear fitting, determine the first target area, whose height above the ground is less than the first predetermined height value, in the first area. The first target area is the obstacle area. When there is a second area below the ground in the non-ground area, the eighth unit determines a second target area, whose height below the ground is greater than a second predetermined height value, in the second area. The second target area is the obstacle area.

Optionally, the sixth sub-module may set the disparity value of the pixel of the non-obstacle area in the first disparity map and the disparity value of the pixel of the obstacle edge information as the predetermined values. The sixth sub-module, taking N pixels in the column direction of the first disparity map as a traversal unit, traverses the disparity values of N pixels in each row from the set row of the first disparity map, and determines the target row where the disparity value of the pixel has a jump between the predetermined value and a non-predetermined value. The sixth sub-module is configured to determine the obstacle pixel columnar area in the obstacle area by taking N pixels in the column direction as the column width, and by taking the determined target row as the boundary of the obstacle pixel columnar area in the row direction.

The description for S110 in the above method embodiment may be taken as a reference for the specific operations performed by the parts included in the first determining module 2410, which will not be described in detail here.

The clustering module 2420 is configured to cluster the multiple obstacle pixel areas to obtain at least one class cluster. For example, the clustering module 2420 may cluster multiple obstacle pixel columnar areas. The clustering module 2420 may include a seventh sub-module and an eighth sub-module. The seventh sub-module is configured to determine the spatial location information of the multiple obstacle pixel columnar areas. The eighth sub-module is configured to cluster the multiple obstacle pixel columnar areas according to the spatial location information of the multiple obstacle pixel columnar areas. For example, for any obstacle pixel columnar area, the eighth sub-module determines the attribute information of the obstacle pixel columnar area according to the pixels contained in the obstacle pixel columnar area, and determines the spatial location information of the obstacle pixel columnar area according to the attribute information of the obstacle pixel columnar area. The attribute information of the obstacle pixel columnar area may include: at least one of bottom information of the pixel columnar area, top information of the pixel columnar area, disparity value of the pixel columnar area, and column information of the pixel columnar area. The spatial location information of the obstacle pixel columnar area may include: the coordinate of the obstacle pixel columnar area on the horizontal coordinate axis and the coordinate of the obstacle pixel columnar area on the depth coordinate axis. The spatial location information of the obstacle pixel columnar area may include: a highest point coordinate of the obstacle pixel columnar area on the vertical coordinate axis and the lowest point coordinate of the obstacle pixel columnar area on the vertical coordinate axis. The highest point coordinate and the lowest point coordinate are used for determining the height of the obstacle. The description for S120 in the above method embodiment may be taken as a reference for the specific operations performed by the parts included in the clustering module 2420, which will not be described in detail here.

The second determining module 2430 is configured to determine the obstacle detection result according to the obstacle pixel areas belonging to the same class cluster. The second determining module may include: at least one of a ninth sub-module and a tenth sub-module. The ninth sub-module is configured to determine the obstacle bounding-box in the environment image according to the spatial location information of the obstacle pixel columnar areas belonging to the same class cluster. The tenth sub-module is configured to determine the spatial location information of the obstacle according to the spatial location information of the obstacle pixel columnar areas belonging to the same class cluster. For example, the tenth sub-module may determine the distances between multiple obstacle pixel columnar areas and the camera device generating the environment image according to the spatial location information of the multiple obstacle pixel columnar areas belonging to the same class cluster, and may determine the spatial location information of the obstacle according to the spatial location information of the obstacle pixel columnar area that is closest to the camera device. The description for S130 in the above method embodiment may be taken as a reference for the specific operations performed by the parts included in the second determining module 2430, which will not be described in detail here.

The training module 2440 is configured to train the CNN. For example, the training module 2440 inputs one of the binocular image samples into the CNN to be trained, after the CNN performs disparity analysis, obtain the disparity map of the left eye image sample and the disparity map of the right eye image sample based on the output of the CNN. The training module 2440 reconstructs the right eye image according to the disparity map of the right eye image sample and the left eye image sample. The training module 2440 reconstructs the left eye image according to the disparity map of the left eye image sample and the right eye image sample. The training module 2440 adjusts the network parameter of the CNN according to the difference between the reconstructed left eye image and the left eye image sample and the difference between the reconstructed right eye image and the right eye image sample. The above description for FIG. 22 may be taken as a reference for the specific operations performed by the training module 2440, which will not be described in detail here.

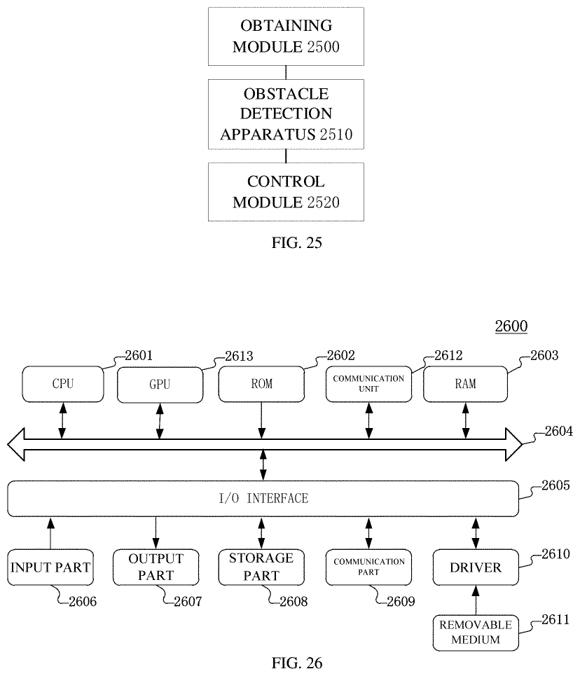

FIG. 25 is a structural schematic diagram of an embodiment of an intelligent driving control apparatus according to the disclosure. The apparatus in FIG. 25 may include: an obtaining module 2500, an obstacle detection apparatus 2510 and a control module 2520.

The obtaining module 2500 is configured to obtain the environment image of the intelligent device during moving through the image acquisition apparatus provided on the intelligent device. The obstacle detection apparatus 2510 is configured to perform obstacle detection to the environment image, and to determine the obstacle detection result. The control module 2520 is configured to generate and output the control instruction according to the obstacle detection result.

Exemplary Device

FIG. 26 illustrates an exemplary device 2600 suitable for implementing the disclosure. The device 2600 may be a control system/electronic system configured in an automobile, a mobile terminal (for example, a smart mobile phone), a PC (for example, a desktop computer or a notebook computer), a tablet computer and a server, etc. In FIG. 26, the device 2600 includes one or more processors, a communication unit and the like. The one or more processors may be one or more Central Processing Units (CPUs) 2601 and/or one or more Graphics Processing Units (GPUs) 2613 configured to perform visual tracking by use of a neural network, etc. The processor may execute various proper actions and processing according to an executable instruction stored in a Read-Only Memory (ROM) 2602 or an executable instruction loaded from a storage part 2608 to a Random Access Memory (RAM) 2603. The communication unit 2612 may include, but may not be limited to, a network card, and the network card may include, but may not be limited to, an Infiniband (IB) network card. The processor may communicate with the ROM 2602 and/or the RAM 2603 to execute the executable instruction, is connected with the communication unit 2612 through a bus 2604 and communicates with another target device through the communication unit 2612, thereby completing the corresponding steps in the disclosure.

The operation executed according to each instruction may refer to the related descriptions in the method embodiment and will not be described herein in detail. In addition, various programs and data required by the operations of the apparatus may further be stored in the RAM 2603. The CPU 2601, the ROM 2602 and the RAM 2603 are connected with one another through a bus 2604. Under the condition that there is the RAM 2603, the ROM 2602 is an optional module. The RAM 2603 stores the executable instruction, or the executable instruction is written in the ROM 2602 during running, and through the executable instruction, the CPU 2601 executes the steps of the target object orientation determination method or the intelligent driving control method. An Input/Output (I/O) interface 2605 is also connected to the bus 2604. The communication unit 2612 may be integrated, and may also be arranged to include multiple sub-modules (for example, multiple IB network cards) connected with the bus respectively. The following components are connected to the I/O interface 2605: an 09 2606 including a keyboard, a mouse and the like; an output part 2607 including a Cathode-Ray Tube (CRT), a Liquid Crystal Display (LCD), a speaker and the like; the storage part 2608 including a hard disk and the like; and a communication part 2609 including a Local Area Network (LAN) card and a network interface card of a modem and the like. The communication part 2609 executes communication processing through a network such as the Internet. A driver 2610 is also connected to the I/O interface 2605 as required. A removable medium 2611, for example, a magnetic disk, an optical disk, a magneto-optical disk and a semiconductor memory, is installed on the driver 2610 as required such that a computer program read therefrom is installed in the storage part 2608 as required.

It is to be particularly noted that the architecture shown in FIG. 16 is only an optional implementation mode and the number and types of the components in FIG. 26 may be selected, deleted, added or replaced according to a practical requirement in a specific practice process. In terms of arrangement of different functional components, an implementation manner such as separate arrangement or integrated arrangement may also be adopted. For example, the GPU 2613 and the CPU 2601 may be separately arranged. For another example, the GPU 2613 may be integrated to the CPU 2601, and the communication unit may be separately arranged and may also be integrated to the CPU 2601 or the GPU 2613. All these alternative implementation modes shall fall within the scope of protection disclosed in the disclosure.

Particularly, according to the implementation mode of the disclosure, the process described below with reference to the flowchart may be implemented as a computer software program. For example, the implementation mode of the disclosure includes a computer program product, which includes a computer program physically included in a machine-readable medium, the computer program includes a program code configured to execute the steps shown in the flowchart, and the program code may include an instruction corresponding to the steps in the method provided in the disclosure. In this implementation mode, the computer program may be downloaded from the network and installed through the communication part 2609 and/or installed from the removable medium 2611. The computer program is executed by the CPU 2601 to execute the instruction for implementing the corresponding steps in the disclosure. In one or multiple optional implementation modes, the embodiments of the disclosure also provide a computer program product for storing a computer readable instruction. When executed, the instruction enables the computer to perform the obstacle detection method or the intelligent driving control method in any above embodiment.

The computer program product may be specifically realized by means of hardware, software or a combination thereof. In an optional example, the computer program product is specifically embodied as a computer storage medium, and in another optional example, the computer program product is specifically embodied as software products, such as a Software Development Kit (SDK). In one or multiple optional implementation modes, the embodiments of the disclosure also provide another obstacle detection method and intelligent driving control method, and the corresponding apparatus and electronic device, a computer storage medium, a computer program and a computer program product. The method includes that: the first apparatus sends an obstacle detection instruction or intelligent driving control instruction to the second apparatus, the instruction causing the second apparatus to perform the obstacle detection method or the intelligent driving control method in any possible embodiment; and the first apparatus receives the obstacle detection result or the intelligent driving control result sent by the second apparatus.

In some embodiments, the obstacle detection instruction or the intelligent driving control instruction may specifically be a calling instruction. The first apparatus may instruct the second apparatus in a calling manner to execute an obstacle detection operation or an intelligent driving control operation. Correspondingly, the second apparatus, responsive to receiving the calling instruction, may execute the steps and/or flows in any embodiment of the obstacle detection method or the intelligent driving control method. It is to be understood that terms “first”, “second” and the like in the embodiment of the disclosure are only adopted for distinguishing and should not be understood as limits to the embodiment of the disclosure. It is also to be understood that, in the disclosure, “multiple” may refer to two or more than two and “at least one” may refer to one, two or more than two. It is also to be understood that, for any component, data or structure mentioned in the disclosure, the number thereof can be understood to be one or multiple if there is no specific limits or opposite revelations are presented in the context. It is also to be understood that, in the disclosure, the descriptions about each embodiment are made with emphasis on differences between each embodiment and the same or similar parts may refer to each other and will not be elaborated for simplicity. The method, apparatus, electronic device and computer-readable storage medium of the disclosure may be implemented in many manners. For example, the method, apparatus, electronic device and computer-readable storage medium of the disclosure may be implemented through software, hardware, firmware or any combination of the software, the hardware and the firmware. The sequence of the steps of the method is only for description, and the steps of the method of the disclosure are not limited to the sequence specifically described above, unless otherwise specified in another manner. In addition, in some implementation modes, the disclosure may also be implemented as a program recorded in a recording medium, and the program includes a machine-readable instruction configured to implement the method according to the disclosure. Therefore, the disclosure further covers the recording medium storing the program configured to execute the method according to the disclosure. The descriptions of the disclosure are made for examples and description and are not exhaustive or intended to limit the disclosure to the disclosed form. Many modifications and variations are apparent to those of ordinary skill in the art. The implementation modes are selected and described to describe the principle and practical application of the disclosure better and enable those of ordinary skill in the art to understand the embodiment of the disclosure and further design various implementation modes suitable for specific purposes and with various modifications.

What is claimed is:

1. An obstacle detection method, comprising:
obtaining a first disparity map of an environment image, the environment image being an image representing information of a space environment where an intelligent device is moving;
determining a plurality of obstacle pixel areas in the first disparity map of the environment image;
clustering the plurality of obstacle pixel areas to obtain at least one class cluster; and
determining an obstacle detection result according to obstacle pixel areas belonging to the same class cluster.

2. The method as claimed in claim 1, wherein the environment image comprises a monocular image;
wherein after obtaining the first disparity map of the environment image, the method further comprises:
obtaining a first mirror image by mirroring the monocular image, and obtaining a disparity map of the first mirror image;
performing disparity adjustment on the first disparity map of the monocular image according to the disparity map of the first mirror image, to obtain the first disparity map subjected to disparity adjustment; and
wherein determining the plurality of obstacle pixel areas in the first disparity map of the environment image comprises:
determining the plurality of obstacle pixel areas in the first disparity map subjected to disparity adjustment.

3. The method as claimed in claim 2, wherein performing disparity adjustment on the first disparity map of the monocular image according to the disparity map of the first mirror image, to obtain the first disparity map subjected to disparity adjustment comprises:
obtaining a second mirror image after mirroring the disparity map of the first mirror image; and
performing disparity adjustment on the first disparity map according to a weight distribution map of the first disparity map and a weight distribution map of the second mirror image, to obtain the first disparity map subjected to disparity adjustment;
wherein the weight distribution map of the first disparity map comprises weight values corresponding to a plurality of disparity values in the first disparity map, and wherein the weight distribution map of the second mirror image comprises weights corresponding to the plurality of disparity values in the second mirror image.

4. The method as claimed in claim 3, wherein the weight distribution maps comprise at least one of: a first weight distribution map, or a second weight distribution map;
wherein the first weight distribution map is a weight distribution map uniformly set for a plurality of environment images; and
wherein the second weight distribution map is a weight distribution map respectively set for different environment images.

5. The method as claimed in claim 4, wherein the first weight distribution map comprises at least two areas separated to the left and right, and wherein different areas have different weight values.

6. The method as claimed in claim 5, wherein:
when the monocular image is a left eye image:
for any two areas in the first weight distribution map of the first disparity map, the weight value of the area on the right is not less than the weight value of the area on the left;
for any two areas in the first weight distribution map of the second mirror image, the weight value of the area on the right is not less than the weight value of the area on the left;
for at least one area in the first weight distribution map of the first disparity map, the weight value of a left part of the area is not greater than the weight value of a right part of the area; and
for at least one area in the first weight distribution map of the second mirror image, the weight value of a left part of the area is not greater than the weight value of a right part of the area; or
when the monocular image is a right eye image:
for any two areas in the first weight distribution map of the first disparity map, weight value of the area on the left is not less than the weight value of the area on the right;
for any two areas in the first weight distribution map of the second mirror image, the weight value of the area on the left is not less than the weight value of the area on the right;
for at least one area in the first weight distribution map of the first disparity map, the weight value of the right part of the area is not greater than the weight value of the left part of the area; and
for at least one area in the first weight distribution map of the second mirror image, the weight value of the right part of the area is not greater than the weight value of the left part of the area.

7. The method as claimed in claim 4, wherein a setting mode of the second weight distribution map of the first disparity map comprises:
mirroring the first disparity map to form a mirror disparity map; and
according to a disparity value in the mirror disparity map of the first disparity map, setting the weight value in the second weight distribution map of the first disparity map, according to a disparity value in the mirror disparity map of the first disparity map,
wherein setting the weight value in the second weight distribution map of the first disparity map according to the disparity value in the mirror disparity map of the first disparity map comprises:
for a pixel at any position in the mirror disparity map:
when the disparity value of the pixel at the position satisfies a first predetermined condition, setting the weight value of the pixel at the position in the second weight distribution map of the first disparity map as a first value; or
when the disparity value of the pixel at the position does not satisfy the first predetermined condition, setting the weight value of the pixel at the position in the second weight distribution map of the first disparity map as a second value, wherein the first value is greater than the second value,
wherein the first predetermined condition comprises: the disparity value of the pixel at the position is greater than a first reference value of the pixel at the position; and the first reference value of the pixel at the position is set according to the disparity value of the pixel at the position in the first disparity map and a constant value that is greater than zero.

8. The method as claimed in claim 4, wherein a setting mode of the second weight distribution map of the second mirror image comprises:
setting the weight value in the second weight distribution map of the second mirror image according to the disparity value in the first disparity map,
wherein setting the weight value in the second weight distribution map of the second minor image according to the disparity value in the first disparity map comprises:
for the pixel at any position in the second minor image:
when the disparity value of the pixel at the position in the first disparity map satisfies a second predetermined condition, setting the weight value of the pixel at the position in the second weight distribution map of the second minor image as a third value; or
when the disparity value of the pixel at the position in the first disparity map does not satisfy the second predetermined condition, setting the weight value of the pixel at the position in the second weight distribution map of the second mirror image as a fourth value, wherein the third value is greater than the fourth value,
wherein the second predetermined condition comprises: the disparity value of the pixel at the position in the first disparity map is greater than a second reference value of the pixel at the position, and the second reference value of the pixel at the position is set according to the disparity value of the pixel at the position in the minor disparity map of the first disparity map and a constant value that is greater than zero.

9. The method as claimed in claim 4, wherein, performing disparity adjustment on the first disparity map according to the weight distribution map of the first disparity map and the weight distribution map of the second mirror image, to obtain the first disparity map subjected to disparity adjustment comprises:
adjusting a disparity value in the first disparity map according to the first weight distribution map and the second weight distribution map of the first disparity map;
adjusting a disparity value in the second mirror image according to the first weight distribution map and the second weight distribution map of the second mirror image; and
combining the first disparity map subjected to disparity adjustment and the second mirror image subjected to disparity value adjustment to finally obtain the first disparity map subjected to disparity adjustment.

10. The method as claimed in claim 1, wherein the environment image comprises the monocular image;
wherein obtaining the first disparity map of the environment image comprises:
performing disparity analysis on the monocular image with a Convolutional Neural Network (CNN), and obtaining a first disparity map of the monocular image based on an output of the CNN, wherein the CNN is trained with binocular image samples,
wherein a training process of the CNN comprises:
inputting one of the binocular image samples into a CNN to-be-trained to conduct disparity analysis, obtaining the disparity map of a left eye image sample and the disparity map of a right eye image sample based on the output of the CNN;
reconstructing the right eye image according to the left eye image sample and the disparity map of the right eye image sample;
reconstructing the left eye image according to the right eye image sample and the disparity map of the left eye image sample; and
adjusting a network parameter of the CNN according to a difference between the reconstructed left eye image and the left eye image sample and a difference between the reconstructed right eye image and the right eye image sample.

11. The method as claimed in claim 1, wherein determining a plurality of obstacle pixel areas in the first disparity map of the environment image comprises:
performing edge detection on the first disparity map of the environment image, to obtain obstacle edge information;
determining an obstacle area in the first disparity map of the environment image; and
determining a plurality of obstacle pixel columnar areas in the obstacle area according to the obstacle edge information,
wherein determining the obstacle area in the first disparity map of the environment image comprises:
performing statistical analysis on disparity values of each row of pixels in the first disparity map, to obtain statistical information of the disparity values of each row of pixels;
determining a statistical disparity map based on the statistical information of the disparity values of each row of pixels;
performing first linear fitting on the statistical disparity map, and determining a ground area and a non-ground area according to a result of the first linear fitting; and
determining the obstacle area according to the non-ground area, wherein the non-ground area comprises one of: a first area above the ground, or a first area above the ground and a second area below the ground,
wherein determining the obstacle area according to the non-ground area comprises:
performing second linear fitting on the statistical disparity map, and determining in the first area a first target area whose height above the ground is less than a first predetermined height value, according to a result of the second linear fitting, wherein the first target area is the obstacle area; and
when there is a second area below the ground in the non-ground area, determining in the second area a second target area whose height below the ground is greater than a second predetermined height value, wherein the second target area is the obstacle area.

12. The method as claimed in claim 11, wherein determining the plurality of obstacle pixel columnar areas in the obstacle area of the first disparity map according to the obstacle edge information comprises:
setting a disparity value of a pixel of a non-obstacle area in the first disparity map and a disparity value of a pixel of the obstacle edge information as predetermined values;
taking N pixels in a column direction of the first disparity map as a traversal unit, traversing the disparity values of N pixels in each row from a set row of the first disparity map, and determining a target row where the disparity value of the pixel has a jump between the predetermined value and a non-predetermined value, wherein N is a positive integer; and
determining the obstacle pixel columnar area in the obstacle area by taking N pixels in the column direction as a column width, and taking the determined target row as the boundary of the obstacle pixel columnar area in the row direction.

13. The method as claimed in claim 1, wherein the obstacle pixel area comprises the obstacle pixel columnar area;
wherein clustering the plurality of obstacle pixel areas comprises:
determining spatial location information of the plurality of obstacle pixel columnar areas; and
clustering the plurality of obstacle pixel columnar areas according to the spatial location information of the plurality of obstacle pixel columnar areas,
wherein determining the spatial location information of the plurality of obstacle pixel columnar areas comprises:
for any obstacle pixel columnar area, determining attribute information of the obstacle pixel columnar area according to pixels contained in the obstacle pixel columnar area, and determining the spatial location information of the obstacle pixel columnar area according to the attribute information of the obstacle pixel columnar area, wherein:
the attribute information of the obstacle pixel columnar area comprises at least one of: bottom information of the pixel columnar area, top information of the pixel columnar area, disparity value of the pixel columnar area, and column information of the pixel columnar area;
the spatial location information of the obstacle pixel columnar area comprises: a coordinate of the obstacle pixel columnar area on a horizontal coordinate axis and a coordinate of the obstacle pixel columnar area on a depth coordinate axis; and
the spatial location information of the obstacle pixel columnar area further comprises: a highest point coordinate of the obstacle pixel columnar area on a vertical coordinate axis and a lowest point coordinate of the obstacle pixel columnar area on the vertical coordinate axis, wherein the highest point coordinate and the lowest point coordinate are used for determining the height of the obstacle.

14. The method as claimed in claim 1, wherein the obstacle pixel area comprises the obstacle pixel columnar area;
wherein determining the obstacle detection result according to obstacle pixel areas belonging to the same class cluster comprises:
determining an obstacle bounding-box in the environment image according to the spatial location information of the obstacle pixel columnar areas belonging to the same class cluster; and/or
determining the spatial location information of the obstacle according to the spatial location information of the obstacle pixel columnar areas belonging to the same class cluster,
wherein determining the spatial location information of the obstacle according to the spatial location information of the obstacle pixel columnar areas belonging to the same class cluster comprises:
determining distances between a plurality of obstacle pixel columnar areas and a camera device generating the environment image, according to the spatial location information of the plurality of obstacle pixel columnar areas belonging to the same class cluster; and
determining the spatial location information of the obstacle according to the spatial location information of the obstacle pixel columnar area that is closest to the camera device.

15. An intelligent driving control method, comprising:
obtaining an environment image of an intelligent device during moving via an image acquisition apparatus mounted on the intelligent device;
obtaining a first disparity map of the environment image;
determining a plurality of obstacle pixel areas in the first disparity map of the environment image;
clustering the plurality of obstacle pixel areas to obtain at least one class cluster;
determining an obstacle detection result according to obstacle pixel areas belonging to the same class cluster; and
generating and outputting a control instruction according to the obstacle detection result.

16. An electronic device, comprising:
at least one processor; and
a non-transitory computer readable storage, coupled to the at least one processor and storing at least one computer executable instruction thereon which, when executed by the at least one processor, causes the at least one processor to:
obtain a first disparity map of an environment image, the environment image being an image representing information of a space environment where an intelligent device is moving;
determine a plurality of obstacle pixel areas in the first disparity map of the environment image;
cluster the plurality of obstacle pixel areas to obtain at least one class cluster; and
determine an obstacle detection result according to the obstacle pixel areas belonging to the same class cluster.

17. The electronic device as claimed in claim 16, wherein the at least one processor is further configured to:
obtain a first mirror image by mirroring the monocular image in the environment image, to obtain a disparity map of the first mirror image; and
perform disparity adjustment on the first disparity map of the monocular image according to the disparity map of the first mirror image to obtain the first disparity map subjected to disparity adjustment;
wherein the at least one processor is configured to determine the plurality of obstacle pixel areas in the first disparity map of the environment image is configured to:
determine the plurality of multiple obstacle pixel areas in the first disparity map subjected to disparity adjustment.

18. The electronic device as claimed in claim 17, wherein the at least one processor configured to perform the disparity adjustment on the first disparity map of the monocular image according to the disparity map of the first mirror image to obtain the first disparity map subjected to disparity adjustment is configured to:
obtain a second mirror image after mirroring the disparity map of the first mirror image; and
perform disparity adjustment to the first disparity map according to a weight distribution map of the first disparity map and a weight distribution map of the second mirror image, to obtain the first disparity map subjected to disparity adjustment;
wherein the weight distribution map of the first disparity map comprises weight values corresponding to a plurality of disparity values in the first disparity map, and the weight distribution map of the second mirror image comprises weights corresponding to the plurality of disparity values in the second mirror image.

19. An electronic device, comprising:
at least one processor; and
a non-transitory computer readable storage, coupled to the at least one processor and storing at least one computer executable instruction thereon which, when executed by the at least one processor, causes the at least one processor to perform the method as claimed in claim 15.

20. A non-transitory computer-readable storage medium storing computer programs which, when executed by a processor, cause the processor to perform the method as claimed in claim 1.
